(19) United States
(12) Patent Application Publication
(10) Pub. No.: US 2023/0037929 A1
(43) Pub. Date: Feb. 9, 2023

(54) SELECTIVE DEPOSITION/PATTERNING FOR LAYERED WAVEGUIDE FABRICATION

(71) Applicant: Meta Platforms Technologies, LLC, Menlo Park, CA (US)

(72) Inventors: Austin LANE, Snohomish, WA (US); Richard FARRELL, Seattle, WA (US); Ankit VORA, Bothell, WA (US)

(21) Appl. No.: 17/815,944

(22) Filed: Jul. 29, 2022

Related U.S. Application Data
(60) Provisional application No. 63/230,532, filed on Aug. 6, 2021.

(51) Int. Cl. F21V 8/00; G02B 27/01

(52) U.S. Cl. CPC G02B 6/0065; G02B 6/0076; G02B 6/0016; G02B 6/0038; G02B 27/0172; G02B 6/0031

(57) ABSTRACT

Layered waveguides, multi-layer waveguide displays with layered waveguides, and methods of fabricating layered waveguides with selective bonding material deposition and/or patterning.

### RELATED APPLICATIONS

This application claims the benefit of and priority to U.S. Provisional Application No. 63/230,532, filed Aug. 6, 2021 and titled “SELECTIVE OPTICAL ADHESIVE DEPOSITION/PATTERNING FOR LAYERED WAVEGUIDE FABRICATION;” which is hereby incorporated by reference in its entirety for all purposes.

### BACKGROUND

An artificial reality system, such as a head-mounted display (HMD) or heads-up display (HUD) system, generally includes a near-eye display (e.g., in the form of a headset or a pair of glasses) configured to present content to a user via an electronic or optic display in front of the user's eyes. The near-eye display may present virtual objects or combine images of real objects with virtual objects, as in virtual reality (VR), augmented reality (AR), or mixed reality (MR) applications. For example, in an AR system, a user may view both images of virtual objects (e.g., computer-generated images (CGIs)) and the surrounding environment by, for example, seeing through transparent display glasses or lenses (often referred to as optical see-through).

One example of an optical see-through AR system may use a waveguide-based optical display, where the light of projected images may be coupled into a waveguide (e.g., a transparent substrate), propagate within the waveguide, and then be coupled out of the waveguide at different locations. In some optical see-through AR systems, the light of the projected images may be coupled into and out of the waveguide using diffractive optical elements, such as surface-relief gratings or holographic gratings. Light from the surrounding environment may also pass through the diffractive optical elements in a see-through region of the waveguide and reach the user's eyes.

### SUMMARY

This disclosure relates generally to multi-layer waveguides, multi-layer waveguide displays, and method of fabricating multi-layer waveguides and their displays. Various inventive embodiments are described herein, including devices, systems, methods, materials, and the like.

Certain aspects are directed to a method of fabricating one or more multi-layer waveguides. The method includes receiving or forming a first waveguide layer and forming on the first waveguide layer a bonding layer (e.g., a optically-clear adhesive material layer) with one or more dicing lanes. The method also includes forming a bonded waveguide stack by bonding a second waveguide layer to the first waveguide layer and cutting through the bonded waveguide stack along the one or more dicing lanes to form one or more multi-layer waveguides. In addition, the method includes forming the one or more multi-layer waveguides displays using the one or more multi-layer waveguides.

Certain aspects are directed to a method of fabricating one or more multi-layer waveguide displays. The method includes receiving or forming a first waveguide layer having one or more gratings (e.g., input and/or output gratings). The method also including forming on the first waveguide layer an optically-clear adhesive material layer with one or more dicing lanes. The method also includes forming a bonded waveguide stack by bonding a second waveguide layer to the first waveguide layer and cutting through the bonded waveguide stack along the one or more dicing lanes to form one or more multi-layer waveguide displays. The method also includes forming the one or more multi-layer waveguides displays using the one or more multi-layer waveguides.

Certain aspects are directed to a method of fabricating one or more multi-layer waveguides. The method includes receiving or forming a first waveguide layer and depositing a sacrificial material on the first waveguide layer along one or more dicing lanes. The method also includes depositing an optically-clear adhesive material in a region within an inner perimeter formed by the one more dicing lanes, forming a bonded waveguide stack by bonding a second waveguide layer to the first waveguide layer, and cutting through the bonded waveguide stack along the one or more dicing lanes through the sacrificial material to form one or more multi-layer waveguides.

Certain aspects are directed to a multi-layer waveguide fabricated by receiving or forming a first waveguide layer, depositing a sacrificial material on the first waveguide layer along one or more dicing lanes, depositing an optically-clear adhesive material in a region within an inner perimeter formed by the one more dicing lanes, forming a bonded waveguide stack by bonding a second waveguide layer to the first waveguide layer, and cutting through the bonded waveguide stack along the one or more dicing lanes through the sacrificial material to form one or more multi-layer waveguides.

Certain aspects are directed to a multi-layer waveguide display fabricated by receiving or forming a first waveguide layer with one or more gratings and forming, on the first waveguide layer, an optically-clear adhesive material layer with one or more dicing lanes. The second waveguide layer is bonded to the first waveguide layer to form a waveguide stack and the bonded waveguide stack is cut along the one or more dicing lanes to form one or more multi-layer waveguides. The multi-layer waveguide display is formed using the one or more multi-layer waveguides.

Certain aspects are directed to a multi-layer waveguide display comprising a layered waveguide and one or one or more grating couplers configured to diffractively couple display light into or out of the layered waveguide and/or refractively transmit ambient light through the layered waveguide. The layered waveguide is fabricated by cutting through a bonded waveguide stack along one or more dicing lanes in at least one of a plurality of waveguide layers of the bonded waveguide stack, wherein the one or more dicing lanes free of a bonding material (e.g., an adhesive material).

Certain aspects are directed to one or more multi-layer waveguides fabricated by receiving or forming a first waveguide layer and forming, on the first waveguide layer, an optically-clear adhesive material layer. The optically-clear adhesive material layer having one or more dicing lanes free of optically-clear adhesive material. The one or more multi-layer waveguides are further fabricated by bonding a second waveguide layer to the first waveguide layer to form a waveguide stack and cutting through the bonded waveguide stack along the one or more dicing lanes to form the one or more multi-layer waveguides.

Certain aspects are directed to a method of fabricating one or more multi-layer waveguides. The method includes receiving or forming a first waveguide layer and depositing, on the first waveguide layer, a sacrificial material in one or more regions along one or more dicing lanes. The method also includes depositing a bonding material at least in part within inner perimeters of the one or more regions with the sacrificial material and bonding a second waveguide layer to the first waveguide layer with the bonding material to form a bonded waveguide stack. In addition, the method includes cutting through the bonded waveguide stack along the one or more dicing lanes to form one or more multi-layer waveguides.

This summary is neither intended to identify key or essential features of the claimed subject matter, nor is it intended to be used in isolation to determine the scope of the claimed subject matter. The subject matter should be understood by reference to appropriate portions of the entire specification of this disclosure, any or all drawings, and each claim. The foregoing, together with other features and examples, will be described in more detail below in the following specification, claims, and accompanying drawings.

### BRIEF DESCRIPTION OF THE DRAWINGS

Illustrative embodiments are described in detail below with reference to the following figures.

FIG. 1 is a simplified block diagram of an example of an artificial reality system environment including a near-eye display according to certain embodiments.

FIG. 2 is a perspective view of an example of a near-eye display in the form of a head-mounted display device for implementing some of the examples disclosed herein.

FIG. 3 is a perspective view of an example of a near-eye display in the form of a pair of glasses for implementing some of the examples disclosed herein.

FIG. 4 illustrates an example of an optical see-through augmented reality system including a waveguide display according to certain embodiments.

FIG. 5A illustrates an example of a near-eye display device including a waveguide display according to certain embodiments.

FIG. 5B illustrates an example of a near-eye display device including a waveguide display according to certain embodiments.

FIG. 6A illustrates an example of an optical see-through augmented reality system including a waveguide display and surface-relief gratings for exit pupil expansion according to certain embodiments.

FIG. 6B illustrates an example of an eyebox including two-dimensional replicated exit pupils according to certain embodiments.

FIG. 7 illustrates an example of a slanted grating in a waveguide display according to certain embodiments.

FIG. 8 illustrates propagations of display light and external light in an example of a waveguide display, according to certain embodiments.

FIG. 9A illustrates propagations of display light in an example of a waveguide display, according to certain embodiments.

FIG. 9B illustrates propagations of display light in an example of a waveguide display having a multi-layer waveguide, according to certain embodiments.

FIG. 10A illustrates propagations of display light in an example of a waveguide display having a multi-layer waveguide, according to certain embodiments.

FIG. 10B illustrates propagations of display light in an example of a waveguide display having a multi-layer waveguide, according to certain embodiments.

FIG. 11A illustrates propagations of display light in an example of a waveguide display having a multi-layer waveguide, according to certain embodiments.

FIG. 11B illustrates propagations of display light in an example of a waveguide display having a multi-layer waveguide, according to certain embodiments.

FIG. 12 is a diagram illustrating an example of a process flow depicting operations of a method of fabricating a multi-layer waveguide, according to certain embodiments.

FIG. 13 is a flowchart depicting operations of an example of a method of fabricating a multi-layer waveguide, according to certain embodiments.

FIG. 14 is a diagram illustrating an example of a process flow depicting operations of a method of fabricating a layered waveguide, according to certain embodiments.

FIG. 15 is a flowchart depicting operations of an example of a method of fabricating a layered waveguide, according to certain embodiments.

FIG. 16 is a diagram illustrating an example of a process flow depicting operations of a method of fabricating a layered waveguide, according to certain embodiments.

FIG. 17 is a flowchart depicting operations of an example of a method of fabricating a layered waveguide, according to certain embodiments.

FIG. 18 is a diagram illustrating an example of a process flow depicting operations of a method of fabricating a layered waveguide, according to certain embodiments.

FIG. 19 is a flowchart depicting operations of an example of a method of fabricating a layered waveguide, according to certain embodiments.

FIG. 20 is a simplified block diagram of an example electronic system of an example near-eye display for implementing some of the examples disclosed herein.

FIG. 21A is a photograph of a bonded waveguide stack fabricated according to an example.

FIG. 21B is a photograph of a waveguide stack fabricated according to an example.

The figures depict embodiments of the present disclosure for purposes of illustration only. One skilled in the art will readily recognize from the following description that alternative embodiments of the structures and methods illustrated may be employed without departing from the principles, or benefits touted, of this disclosure.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION

In the following description, for the purposes of explanation, specific details are set forth in order to provide a thorough understanding of certain inventive embodiments. However, it will be apparent that various embodiments may be practiced without these specific details. The figures and description are not intended to be restrictive.

Techniques disclosed herein relate generally to artificial reality display systems. More specifically, and without limitation, disclosed herein are layered waveguides and their displays for augmented reality or mixed reality systems and methods of fabricating layered waveguides with selective optical adhesive deposition and/or patterning.

In an optical see-through waveguide display system, display light may be coupled into a waveguide by input couplers and then coupled out of the waveguide by output couplers (e.g., grating couplers) towards user's eyes. The waveguide and the couplers may be transparent to visible light such that the user can view the ambient environment through the waveguide display. Due to the different diffraction angles of display light from different fields of view or in different colors, the display light from different fields of view or in different colors may not be uniformly coupled out of the waveguide towards user's eyes.

According to certain embodiments, a layered waveguide may be used to improve the uniformity of the display light from different fields of view or in different colors. The layered waveguide may include multiple waveguide layers having select refractive indices and thicknesses.

In certain examples, methods of fabricating layered waveguides use a dicing process that implements laser ablation or a like process to cut through the bonded layered waveguide stack to singulate individual waveguides. A laser ablation operation may include using a high-powered laser to repeatedly remove material in an area to scribe through the layered waveguide stack. If an optically-clear adhesive (OCA) or other bonding material is present at the edges of the waveguide dies during the dicing operation, the laser ablation or other like destructive process may reduce the bonding strength of the adhesive material at the edges of the individual waveguides. Certain bonding processes may cause residual stress in the layer of adhesive material due to, for example, polymerization shrinkage from ultraviolet (UV) curing or from thermal bonding layers having mismatched coefficients of thermal expansion (CTE). In certain instances, to relieve residual stress in the bonding layer, a delamination front starting at the edges of the waveguides, where bonding strength of the adhesive material may have been degraded during the dicing process, may propagate inward over time cause delamination of the waveguide layers.

In certain implementations, methods of fabricating a layered waveguide remove or avoid forming adhesive material or other bonding material in one or more dicing lanes in the bonded waveguide stack where dicing is to occur. In this way, properties of the bonding layer may not be affected by the dicing process and delamination due to degraded bonding strength resulting from laser ablation or similar process may be avoided.

In certain implementations, methods of fabricating a layered waveguide form a sacrificial material in the one or more dicing lines. The sacrificial material may be formed before depositing the adhesive material to form a damn within which the adhesive material may be deposited by, for example, a drop cast process or an ink jet process. Alternatively, the sacrificial material may be formed in one or more dicing lanes formed in the bonding material.

In the following description, for the purposes of explanation, specific details are set forth in order to provide a thorough understanding of examples of the disclosure. However, it will be apparent that various examples may be practiced without these specific details. For example, devices, systems, structures, assemblies, methods, and other components may be shown as components in block diagram form in order not to obscure the examples in unnecessary detail. In other instances, well-known devices, processes, systems, structures, and techniques may be shown without necessary detail in order to avoid obscuring the examples. The figures and description are not intended to be restrictive. The terms and expressions that have been employed in this disclosure are used as terms of description and not of limitation, and there is no intention in the use of such terms and expressions of excluding any equivalents of the features shown and described or portions thereof. The word “example” is used herein to mean “serving as an example, instance, or illustration.” Any embodiment or design described herein as “example” is not necessarily to be construed as preferred or advantageous over other embodiments or designs.

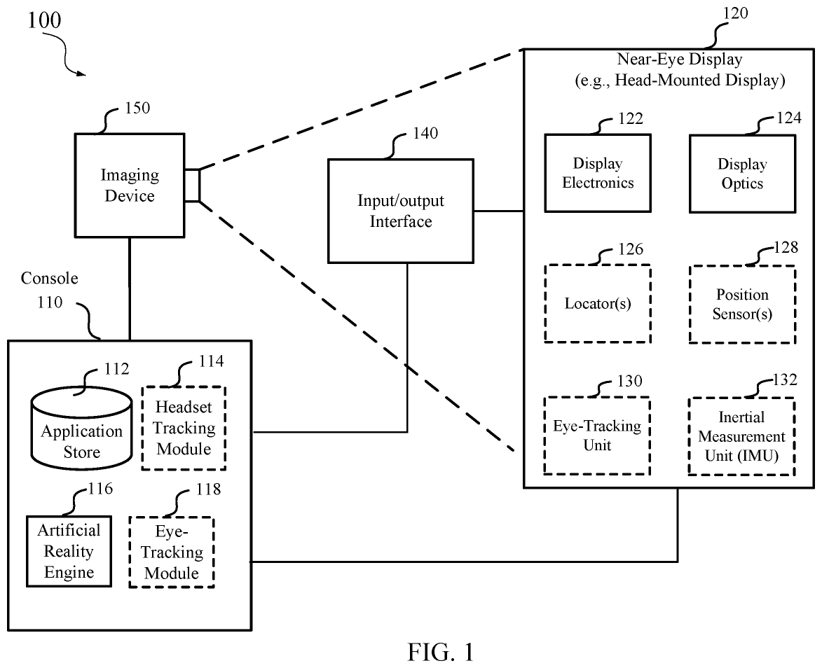

FIG. 1 is a simplified block diagram of an example of an artificial reality system environment 100 including a near-eye display 120 in accordance with certain embodiments. Artificial reality system environment 100 shown in FIG. 1 may include near-eye display 120, an optional external imaging device 150, and an optional input/output interface 140, each of which may be coupled to an optional console 110. While FIG. 1 shows an example of artificial reality system environment 100 including one near-eye display 120, one external imaging device 150, and one input/output interface 140, any number of these components may be included in artificial reality system environment 100, or any of the components may be omitted. For example, there may be multiple near-eye displays 120 monitored by one or more external imaging devices 150 in communication with console 110. In some configurations, artificial reality system environment 100 may not include external imaging device 150, optional input/output interface 140, and optional console 110. In alternative configurations, different or additional components may be included in artificial reality system environment 100.

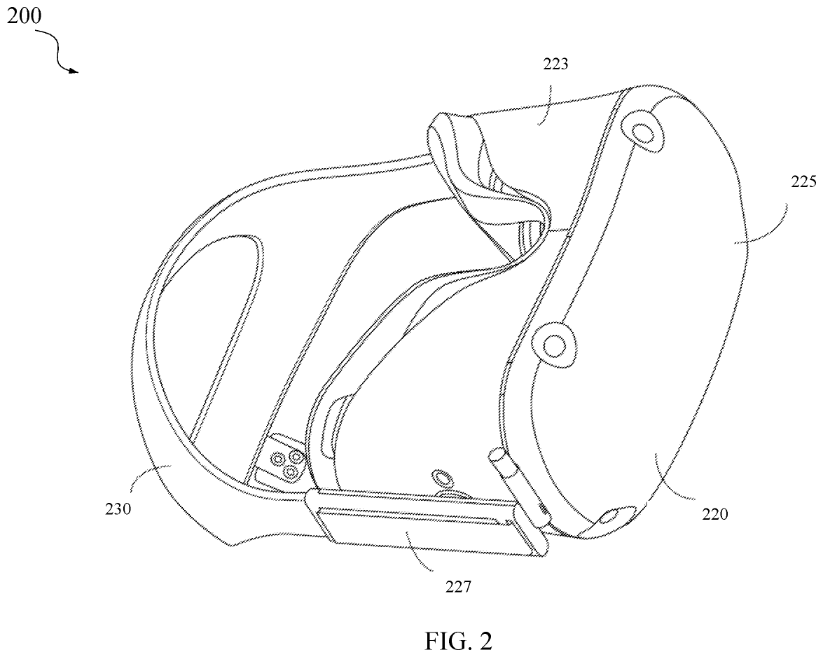

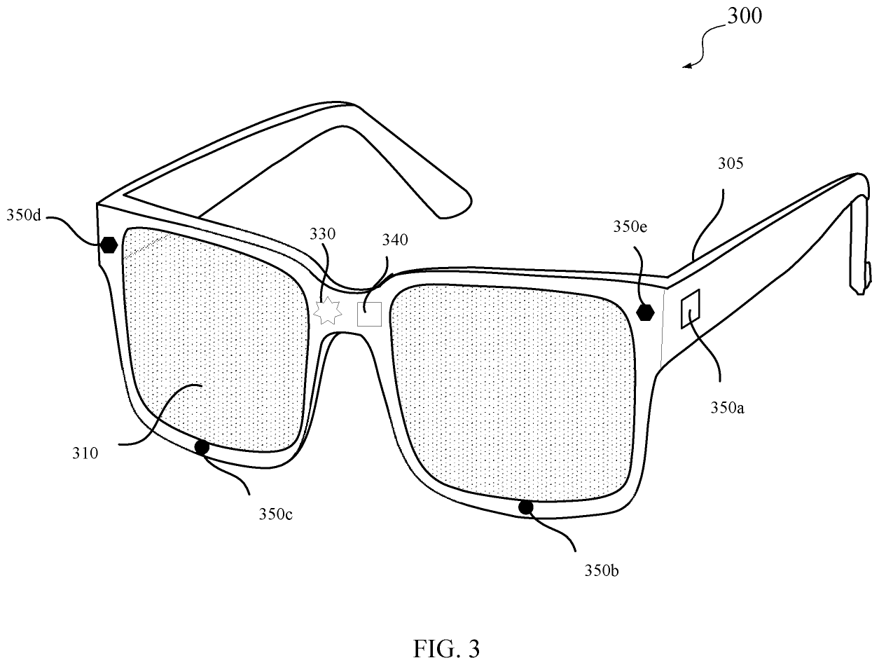

Near-eye display 120 may be a head-mounted display that presents content to a user. Examples of content presented by near-eye display 120 include one or more of images, videos, audio, or any combination thereof. In some embodiments, audio may be presented via an external device (e.g., speakers and/or headphones) that receives audio information from near-eye display 120, console 110, or both, and presents audio data based on the audio information. Near-eye display 120 may include one or more rigid bodies, which may be rigidly or non-rigidly coupled to each other. A rigid coupling between rigid bodies may cause the coupled rigid bodies to act as a single rigid entity. A non-rigid coupling between rigid bodies may allow the rigid bodies to move relative to each other. In various embodiments, near-eye display 120 may be implemented in any suitable form-factor, including a pair of glasses. Some embodiments of near-eye display 120 are further described below with respect to FIGS. 2 and 3. Additionally, in various embodiments, the functionality described herein may be used in a headset that combines images of an environment external to near-eye display 120 and artificial reality content (e.g., computer-generated images). Therefore, near-eye display 120 may augment images of a physical, real-world environment external to near-eye display 120 with generated content (e.g., images, video, sound, etc.) to present an augmented reality to a user.

In various embodiments, near-eye display 120 may include one or more of display electronics 122, display optics 124, and an eye-tracking unit 130. In some embodiments, near-eye display 120 may also include one or more locators 126, one or more position sensors 128, and an inertial measurement unit (IMU) 132. Near-eye display 120 may omit any of eye-tracking unit 130, locators 126, position sensors 128, and IMU 132, or include additional elements in various embodiments. Additionally, in some embodiments, near-eye display 120 may include elements combining the function of various elements described in conjunction with FIG. 1.

Display electronics 122 may display or facilitate the display of images to the user according to data received from, for example, console 110. In various embodiments, display electronics 122 may include one or more display panels, such as a liquid crystal display (LCD), an organic light emitting diode (OLED) display, an inorganic light emitting diode (ILED) display, a micro light emitting diode (μLED) display, an active-matrix OLED display (AMOLED), a transparent OLED display (TOLED), or some other display. For example, in one implementation of near-eye display 120, display electronics 122 may include a front TOLED panel, a rear display panel, and an optical component (e.g., an attenuator, polarizer, or diffractive or spectral film) between the front and rear display panels. Display electronics 122 may include pixels to emit light of a predominant color such as red, green, blue, white, or yellow. In some implementations, display electronics 122 may display a three-dimensional (3D) image through stereoscopic effects produced by two-dimensional panels to create a subjective perception of image depth. For example, display electronics 122 may include a left display and a right display positioned in front of a user's left eye and right eye, respectively. The left and right displays may present copies of an image shifted horizontally relative to each other to create a stereoscopic effect (i.e., a perception of image depth by a user viewing the image).

In certain embodiments, display optics 124 may display image content optically (e.g., using optical waveguides and couplers) or magnify image light received from display electronics 122, correct optical errors associated with the image light, and present the corrected image light to a user of near-eye display 120. In various embodiments, display optics 124 may include one or more optical elements, such as, for example, a substrate, optical waveguides, an aperture, a Fresnel lens, a convex lens, a concave lens, a filter, input/output couplers, or any other suitable optical elements that may affect image light emitted from display electronics 122. Display optics 124 may include a combination of different optical elements as well as mechanical couplings to maintain relative spacing and orientation of the optical elements in the combination. One or more optical elements in display optics 124 may have an optical coating, such as an anti-reflective coating, a reflective coating, a filtering coating, or a combination of different optical coatings.

Magnification of the image light by display optics 124 may allow display electronics 122 to be physically smaller, weigh less, and consume less power than larger displays. Additionally, magnification may increase a field of view of the displayed content. The amount of magnification of image light by display optics 124 may be changed by adjusting, adding, or removing optical elements from display optics 124. In some embodiments, display optics 124 may project displayed images to one or more image planes that may be further away from the user's eyes than near-eye display 120.

Display optics 124 may also be designed to correct one or more types of optical errors, such as two-dimensional optical errors, three-dimensional optical errors, or any combination thereof. Two-dimensional errors may include optical aberrations that occur in two dimensions. Example types of two-dimensional errors may include barrel distortion, pincushion distortion, longitudinal chromatic aberration, and transverse chromatic aberration. Three-dimensional errors may include optical errors that occur in three dimensions. Example types of three-dimensional errors may include spherical aberration, comatic aberration, field curvature, and astigmatism.

Locators 126 may be objects located in specific positions on near-eye display 120 relative to one another and relative to a reference point on near-eye display 120. In some implementations, console 110 may identify locators 126 in images captured by external imaging device 150 to determine the artificial reality headset's position, orientation, or both. A locator 126 may be a light emitting diode (LED), a corner cube reflector, a reflective marker, a type of light source that contrasts with an environment in which near-eye display 120 operates, or any combination thereof. In embodiments where locators 126 are active components (e.g., LEDs or other types of light emitting devices), locators 126 may emit light in the visible band (e.g., about 380 nm to 750 nm), in the infrared (IR) band (e.g., about 750 nm to 1 mm), in the ultraviolet band (e.g., about 10 nm to about 380 nm), in another portion of the electromagnetic spectrum, or in any combination of portions of the electromagnetic spectrum.

External imaging device 150 may include one or more cameras, one or more video cameras, any other device capable of capturing images including one or more of locators 126, or any combination thereof. Additionally, external imaging device 150 may include one or more filters (e.g., to increase signal to noise ratio). External imaging device 150 may be configured to detect light emitted or reflected from locators 126 in a field of view of external imaging device 150. In embodiments where locators 126 include passive elements (e.g., retroreflectors), external imaging device 150 may include a light source that illuminates some or all of locators 126, which may retro-reflect the light to the light source in external imaging device 150. Slow calibration data may be communicated from external imaging device 150 to console 110, and external imaging device 150 may receive one or more calibration parameters from console 110 to adjust one or more imaging parameters (e.g., focal length, focus, frame rate, sensor temperature, shutter speed, aperture, etc.).

Position sensors 128 may generate one or more measurement signals in response to motion of near-eye display 120. Examples of position sensors 128 may include accelerometers, gyroscopes, magnetometers, other motion-detecting or error-correcting sensors, or any combination thereof. For example, in some embodiments, position sensors 128 may include multiple accelerometers to measure translational motion (e.g., forward/back, up/down, or left/right) and multiple gyroscopes to measure rotational motion (e.g., pitch, yaw, or roll). In some embodiments, various position sensors may be oriented orthogonally to each other.

IMU 132 may be an electronic device that generates fast calibration data based on measurement signals received from one or more of position sensors 128. Position sensors 128 may be located external to IMU 132, internal to IMU 132, or any combination thereof. Based on the one or more measurement signals from one or more position sensors 128, IMU 132 may generate fast calibration data indicating an estimated position of near-eye display 120 relative to an initial position of near-eye display 120. For example, IMU 132 may integrate measurement signals received from accelerometers over time to estimate a velocity vector and integrate the velocity vector over time to determine an estimated position of a reference point on near-eye display 120. Alternatively, IMU 132 may provide the sampled measurement signals to console 110, which may determine the fast calibration data. While the reference point may generally be defined as a point in space, in various embodiments, the reference point may also be defined as a point within near-eye display 120 (e.g., a center of IMU 132).

Eye-tracking unit 130 may include one or more eye-tracking systems. Eye tracking may refer to determining an eye's position, including orientation and location of the eye, relative to near-eye display 120. An eye-tracking system may include an imaging system to image one or more eyes and may optionally include a light emitter, which may generate light that is directed to an eye such that light reflected by the eye may be captured by the imaging system. For example, eye-tracking unit 130 may include a non-coherent or coherent light source (e.g., a laser diode) emitting light in the visible spectrum or infrared spectrum, and a camera capturing the light reflected by the user's eye. As another example, eye-tracking unit 130 may capture reflected radio waves emitted by a miniature radar unit. Eye-tracking unit 130 may use low-power light emitters that emit light at frequencies and intensities that would not injure the eye or cause physical discomfort. Eye-tracking unit 130 may be arranged to increase contrast in images of an eye captured by eye-tracking unit 130 while reducing the overall power consumed by eye-tracking unit 130 (e.g., reducing power consumed by a light emitter and an imaging system included in eye-tracking unit 130). For example, in some implementations, eye-tracking unit 130 may consume less than 100 milliwatts of power.

Near-eye display 120 may use the orientation of the eye to, e.g., determine an inter-pupillary distance (IPD) of the user, determine gaze direction, introduce depth cues (e.g., blur image outside of the user's main line of sight), collect heuristics on the user interaction in the VR media (e.g., time spent on any particular subject, object, or frame as a function of exposed stimuli), some other functions that are based in part on the orientation of at least one of the user's eyes, or any combination thereof. Because the orientation may be determined for both eyes of the user, eye-tracking unit 130 may be able to determine where the user is looking. For example, determining a direction of a user's gaze may include determining a point of convergence based on the determined orientations of the user's left and right eyes. A point of convergence may be the point where the two foveal axes of the user's eyes intersect. The direction of the user's gaze may be the direction of a line passing through the point of convergence and the mid-point between the pupils of the user's eyes.

Input/output interface 140 may be a device that allows a user to send action requests to console 110. An action request may be a request to perform a particular action. For example, an action request may be to start or to end an application or to perform a particular action within the application. Input/output interface 140 may include one or more input devices. Example input devices may include a keyboard, a mouse, a game controller, a glove, a button, a touch screen, or any other suitable device for receiving action requests and communicating the received action requests to console 110. An action request received by the input/output interface 140 may be communicated to console 110, which may perform an action corresponding to the requested action. In some embodiments, input/output interface 140 may provide haptic feedback to the user in accordance with instructions received from console 110. For example, input/output interface 140 may provide haptic feedback when an action request is received, or when console 110 has performed a requested action and communicates instructions to input/output interface 140. In some embodiments, external imaging device 150 may be used to track input/output interface 140, such as tracking the location or position of a controller (which may include, for example, an IR light source) or a hand of the user to determine the motion of the user. In some embodiments, near-eye display 120 may include one or more imaging devices to track input/output interface 140, such as tracking the location or position of a controller or a hand of the user to determine the motion of the user.

Console 110 may provide content to near-eye display 120 for presentation to the user in accordance with information received from one or more of external imaging device 150, near-eye display 120, and input/output interface 140. In the example shown in FIG. 1, console 110 may include an application store 112, a headset tracking module 114, an artificial reality engine 116, and an eye-tracking module 118. Some embodiments of console 110 may include different or additional modules than those described in conjunction with FIG. 1. Functions further described below may be distributed among components of console 110 in a different manner than is described here.

In some embodiments, console 110 may include a processor and a non-transitory computer-readable storage medium storing instructions executable by the processor. The processor may include multiple processing units executing instructions in parallel. The non-transitory computer-readable storage medium may be any memory, such as a hard disk drive, a removable memory, or a solid-state drive (e.g., flash memory or dynamic random access memory (DRAM)). In various embodiments, the modules of console 110 described in conjunction with FIG. 1 may be encoded as instructions in the non-transitory computer-readable storage medium that, when executed by the processor, cause the processor to perform the functions further described below.

Application store 112 may store one or more applications for execution by console 110. An application may include a group of instructions that, when executed by a processor, generates content for presentation to the user. Content generated by an application may be in response to inputs received from the user via movement of the user's eyes or inputs received from the input/output interface 140. Examples of the applications may include gaming applications, conferencing applications, video playback application, or other suitable applications.

Headset tracking module 114 may track movements of near-eye display 120 using slow calibration information from external imaging device 150. For example, headset tracking module 114 may determine positions of a reference point of near-eye display 120 using observed locators from the slow calibration information and a model of near-eye display 120. Headset tracking module 114 may also determine positions of a reference point of near-eye display 120 using position information from the fast calibration information. Additionally, in some embodiments, headset tracking module 114 may use portions of the fast calibration information, the slow calibration information, or any combination thereof, to predict a future location of near-eye display 120. Headset tracking module 114 may provide the estimated or predicted future position of near-eye display 120 to artificial reality engine 116.

Artificial reality engine 116 may execute applications within artificial reality system environment 100 and receive position information of near-eye display 120, acceleration information of near-eye display 120, velocity information of near-eye display 120, predicted future positions of near-eye display 120, or any combination thereof from headset tracking module 114. Artificial reality engine 116 may also receive estimated eye position and orientation information from eye-tracking module 118. Based on the received information, artificial reality engine 116 may determine content to provide to near-eye display 120 for presentation to the user. For example, if the received information indicates that the user has looked to the left, artificial reality engine 116 may generate content for near-eye display 120 that mirrors the user's eye movement in a virtual environment. Additionally, artificial reality engine 116 may perform an action within an application executing on console 110 in response to an action request received from input/output interface 140, and provide feedback to the user indicating that the action has been performed. The feedback may be visual or audible feedback via near-eye display 120 or haptic feedback via input/output interface 140.

Eye-tracking module 118 may receive eye-tracking data from eye-tracking unit 130 and determine the position of the user's eye based on the eye tracking data. The position of the eye may include an eye's orientation, location, or both relative to near-eye display 120 or any element thereof. Because the eye's axes of rotation change as a function of the eye's location in its socket, determining the eye's location in its socket may allow eye-tracking module 118 to more accurately determine the eye's orientation.

FIG. 2 is a perspective view of an example of a near-eye display in the form of an HMD device 200 for implementing some of the examples disclosed herein. HMD device 200 may be a part of, e.g., a VR system, an AR system, an MR system, or any combination thereof. HMD device 200 may include a body 220 and a head strap 230. FIG. 2 shows a bottom side 223, a front side 225, and a left side 227 of body 220 in the perspective view. Head strap 230 may have an adjustable or extendible length. There may be a sufficient space between body 220 and head strap 230 of HMD device 200 for allowing a user to mount HMD device 200 onto the user's head. In various embodiments, HMD device 200 may include additional, fewer, or different components. For example, in some embodiments, HMD device 200 may include eyeglass temples and temple tips as shown in, for example, FIG. 3 below, rather than head strap 230.

HMD device 200 may present to a user media including virtual and/or augmented views of a physical, real-world environment with computer-generated elements. Examples of the media presented by HMD device 200 may include images (e.g., two-dimensional (2D) or three-dimensional (3D) images), videos (e.g., 2D or 3D videos), audio, or any combination thereof. The images and videos may be presented to each eye of the user by one or more display assemblies (not shown in FIG. 2) enclosed in body 220 of HMD device 200. In various embodiments, the one or more display assemblies may include a single electronic display panel or multiple electronic display panels (e.g., one display panel for each eye of the user). Examples of the electronic display panel(s) may include, for example, an LCD, an OLED display, an ILED display, a μLED display, an AMOLED, a TOLED, some other display, or any combination thereof. HMD device 200 may include two eye box regions.

In some implementations, HMD device 200 may include various sensors (not shown), such as depth sensors, motion sensors, position sensors, and eye tracking sensors. Some of these sensors may use a structured light pattern for sensing. In some implementations, HMD device 200 may include an input/output interface for communicating with a console. In some implementations, HMD device 200 may include a virtual reality engine (not shown) that can execute applications within HMD device 200 and receive depth information, position information, acceleration information, velocity information, predicted future positions, or any combination thereof of HMD device 200 from the various sensors. In some implementations, the information received by the virtual reality engine may be used for producing a signal (e.g., display instructions) to the one or more display assemblies. In some implementations, HMD device 200 may include locators (not shown, such as locators 126) located in fixed positions on body 220 relative to one another and relative to a reference point. Each of the locators may emit light that is detectable by an external imaging device.

FIG. 3 is a perspective view of an example of a near-eye display 300 in the form of a pair of glasses for implementing some of the examples disclosed herein. Near-eye display 300 may be a specific implementation of near-eye display 120 of FIG. 1, and may be configured to operate as a virtual reality display, an augmented reality display, and/or a mixed reality display. Near-eye display 300 may include a frame 305 and a display 310. Display 310 may be configured to present content to a user. In some embodiments, display 310 may include display electronics and/or display optics. For example, as described above with respect to near-eye display 120 of FIG. 1, display 310 may include an LCD display panel, an LED display panel, or an optical display panel (e.g., a waveguide display assembly).

Near-eye display 300 may further include various sensors 350a, 350b, 350c, 350d, and 350e on or within frame 305. In some embodiments, sensors 350a-350e may include one or more depth sensors, motion sensors, position sensors, inertial sensors, or ambient light sensors. In some embodiments, sensors 350a-350e may include one or more image sensors configured to generate image data representing different fields of views in different directions. In some embodiments, sensors 350a-350e may be used as input devices to control or influence the displayed content of near-eye display 300, and/or to provide an interactive VR/AR/MR experience to a user of near-eye display 300. In some embodiments, sensors 350a-350e may also be used for stereoscopic imaging.

In some embodiments, near-eye display 300 may further include one or more illuminators 330 to project light into the physical environment. The projected light may be associated with different frequency bands (e.g., visible light, infra-red light, ultra-violet light, etc.), and may serve various purposes. For example, illuminator(s) 330 may project light in a dark environment (or in an environment with low intensity of infra-red light, ultra-violet light, etc.) to assist sensors 350a-350e in capturing images of different objects within the dark environment. In some embodiments, illuminator(s) 330 may be used to project certain light patterns onto the objects within the environment. In some embodiments, illuminator(s) 330 may be used as locators, such as locators 126 described above with respect to FIG. 1.

In some embodiments, near-eye display 300 may also include a high-resolution camera 340. Camera 340 may capture images of the physical environment in the field of view. The captured images may be processed, for example, by a virtual reality engine (e.g., artificial reality engine 116 of FIG. 1) to add virtual objects to the captured images or modify physical objects in the captured images, and the processed images may be displayed to the user by display 310 for AR or MR applications.

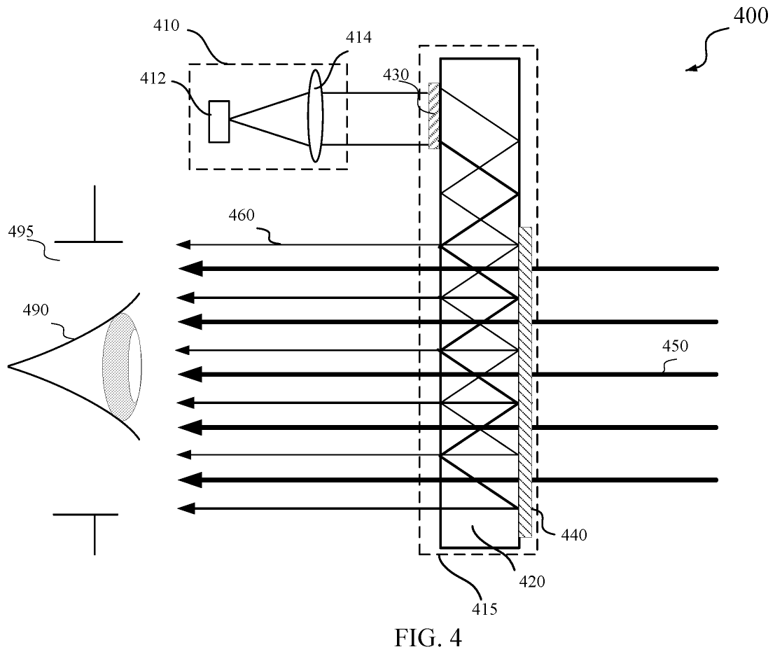

FIG. 4 illustrates an example of an optical see-through augmented reality system 400 including a waveguide display according to certain embodiments. Augmented reality system 400 may include a projector 410 and a combiner 415. Projector 410 may include a light source or image source 412 and projector optics 414. In some embodiments, light source or image source 412 may include one or more micro-LED devices described above. In some embodiments, image source 412 may include a plurality of pixels that displays virtual objects, such as an LCD display panel or an LED display panel. In some embodiments, image source 412 may include a light source that generates coherent or partially coherent light. For example, image source 412 may include a laser diode, a vertical cavity surface emitting laser, an LED, and/or a micro-LED described above. In some embodiments, image source 412 may include a plurality of light sources (e.g., an array of micro-LEDs described above), each emitting a monochromatic image light corresponding to a primary color (e.g., red, green, or blue). In some embodiments, image source 412 may include three two-dimensional arrays of micro-LEDs, where each two-dimensional array of micro-LEDs may include micro-LEDs configured to emit light of a primary color (e.g., red, green, or blue). In some embodiments, image source 412 may include an optical pattern generator, such as a spatial light modulator. Projector optics 414 may include one or more optical components that can condition the light from image source 412, such as expanding, collimating, scanning, or projecting light from image source 412 to combiner 415. The one or more optical components may include, for example, one or more lenses, liquid lenses, mirrors, apertures, and/or gratings. For example, in some embodiments, image source 412 may include one or more one-dimensional arrays or elongated two-dimensional arrays of micro-LEDs, and projector optics 414 may include one or more one-dimensional scanners (e.g., micro-mirrors or prisms) configured to scan the one-dimensional arrays or elongated two-dimensional arrays of micro-LEDs to generate image frames. In some embodiments, projector optics 414 may include a liquid lens (e.g., a liquid crystal lens) with a plurality of electrodes that allows scanning of the light from image source 412.

Combiner 415 may include an input coupler 430 for coupling light from projector 410 into a substrate 420 of combiner 415. Combiner 415 may transmit at least 50% of light in a first wavelength range and reflect at least 25% of light in a second wavelength range. For example, the first wavelength range may be visible light from about 400 nm to about 650 nm, and the second wavelength range may be in the infrared band, for example, from about 800 nm to about 1000 nm. Input coupler 430 may include a volume holographic grating, a diffractive optical element (DOE) (e.g., a surface-relief grating), a slanted surface of substrate 420, or a refractive coupler (e.g., a wedge or a prism). For example, input coupler 430 may include a reflective volume Bragg grating or a transmissive volume Bragg grating. Input coupler 430 may have a coupling efficiency of greater than 30%, 50%, 75%, 90%, or higher for visible light. Light coupled into substrate 420 may propagate within substrate 420 through, for example, total internal reflection (TIR). Substrate 420 may be in the form of a lens of a pair of eyeglasses. Substrate 420 may have a flat or a curved surface, and may include one or more types of dielectric materials, such as glass, quartz, plastic, polymer, poly(methyl methacrylate) (PMMA), crystal, or ceramic. A thickness of the substrate may range from, for example, less than about 1 mm to about 10 mm or more. Substrate 420 may be transparent to visible light.

Substrate 420 may include or may be coupled to a plurality of output couplers 440, each configured to extract at least a portion of the light guided by and propagating within substrate 420 from substrate 420, and direct extracted light 460 to an eyebox 495 where an eye 490 of the user of augmented reality system 400 may be located when augmented reality system 400 is in use. The plurality of output couplers 440 may replicate the exit pupil to increase the size of eyebox 495 such that the displayed image is visible in a larger area. As input coupler 430, output couplers 440 may include grating couplers (e.g., volume holographic gratings or surface-relief gratings), other diffraction optical elements, prisms, etc. For example, output couplers 440 may include reflective volume Bragg gratings or transmissive volume Bragg gratings. Output couplers 440 may have different coupling (e.g., diffraction) efficiencies at different locations. Substrate 420 may also allow light 450 from the environment in front of combiner 415 to pass through with little or no loss. Output couplers 440 may also allow light 450 to pass through with little loss. For example, in some implementations, output couplers 440 may have a very low diffraction efficiency for light 450 such that light 450 may be refracted or otherwise pass through output couplers 440 with little loss, and thus may have a higher intensity than extracted light 460. In some implementations, output couplers 440 may have a high diffraction efficiency for light 450 and may diffract light 450 in certain desired directions (i.e., diffraction angles) with little loss. As a result, the user may be able to view combined images of the environment in front of combiner 415 and images of virtual objects projected by projector 410.

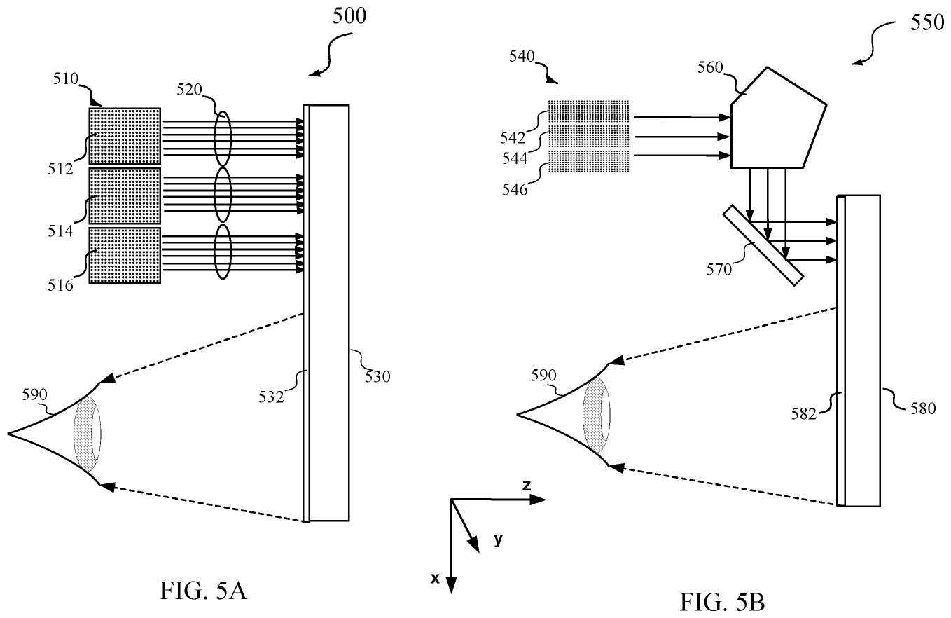

FIG. 5A illustrates an example of a near-eye display (NED) device 500 including a waveguide display 530 according to certain embodiments. NED device 510 may be an example of near-eye display 120, augmented reality system 400, or another type of display device. NED device 500 may include a light source 510, projection optics 520, and waveguide display 530. Light source 510 may include multiple panels of light emitters for different colors, such as a panel of red light emitters 512, a panel of green light emitters 514, and a panel of blue light emitters 516. The red light emitters 512 are organized into an array; the green light emitters 514 are organized into an array; and the blue light emitters 516 are organized into an array. The dimensions and pitches of light emitters in light source 510 may be small. For example, each light emitter may have a diameter less than 2 μm (e.g., about 1.2 μm) and the pitch may be less than 2 μm (e.g., about 1.5 μm). As such, the number of light emitters in each red light emitters 512, green light emitters 514, and blue light emitters 516 can be equal to or greater than the number of pixels in a display image, such as 960×720, 1280×720, 1440×1080, 1920×1080, 2160×1080, or 2560×1080 pixels. Thus, a display image may be generated simultaneously by light source 510. A scanning element may not be used in NED device 500.

Before reaching waveguide display 530, the light emitted by light source 510 may be conditioned by projection optics 520, which may include a lens array. Projection optics 520 may collimate or focus the light emitted by light source 510 to waveguide display 530, which may include a coupler 532 for coupling the light emitted by light source 510 into waveguide display 530. The light coupled into waveguide display 530 may propagate within waveguide display 530 through, for example, total internal reflection as described above with respect to FIG. 4. Coupler 532 may also couple portions of the light propagating within waveguide display 530 out of waveguide display 530 and towards user's eye 590.

FIG. 5B illustrates an example of a near-eye display (NED) device 550 including a waveguide display 580 according to certain embodiments. In some embodiments, NED device 550 may use a scanning mirror 570 to project light from a light source 540 to an image field where a user's eye 590 may be located. NED device 550 may be an example of near-eye display 120, augmented reality system 400, or another type of display device. Light source 540 may include one or more rows or one or more columns of light emitters of different colors, such as multiple rows of red light emitters 542, multiple rows of green light emitters 544, and multiple rows of blue light emitters 546. For example, red light emitters 542, green light emitters 544, and blue light emitters 546 may each include N rows, each row including, for example, 2560 light emitters (pixels). The red light emitters 542 are organized into an array; the green light emitters 544 are organized into an array; and the blue light emitters 546 are organized into an array. In some embodiments, light source 540 may include a single line of light emitters for each color. In some embodiments, light source 540 may include multiple columns of light emitters for each of red, green, and blue colors, where each column may include, for example, 1080 light emitters. In some embodiments, the dimensions and/or pitches of the light emitters in light source 540 may be relatively large (e.g., about 3-5 μm) and thus light source 540 may not include sufficient light emitters for simultaneously generating a full display image. For example, the number of light emitters for a single color may be fewer than the number of pixels (e.g., 2560×1080 pixels) in a display image. The light emitted by light source 540 may be a set of collimated or diverging beams of light.

Before reaching scanning mirror 570, the light emitted by light source 540 may be conditioned by various optical devices, such as collimating lenses or a freeform optical element 560. Freeform optical element 560 may include, for example, a multi-facet prism or another light folding element that may direct the light emitted by light source 540 towards scanning mirror 570, such as changing the propagation direction of the light emitted by light source 540 by, for example, about 90° or larger. In some embodiments, freeform optical element 560 may be rotatable to scan the light. Scanning mirror 570 and/or freeform optical element 560 may reflect and project the light emitted by light source 540 to waveguide display 580, which may include a coupler 582 for coupling the light emitted by light source 540 into waveguide display 580. The light coupled into waveguide display 580 may propagate within waveguide display 580 through, for example, total internal reflection as described above with respect to FIG. 4. Coupler 582 may also couple portions of the light propagating within waveguide display 580 out of waveguide display 580 and towards user's eye 590.

Scanning mirror 570 may include a microelectromechanical system (MEMS) mirror or any other suitable mirrors. Scanning mirror 570 may rotate to scan in one or two dimensions. As scanning mirror 570 rotates, the light emitted by light source 540 may be directed to a different area of waveguide display 580 such that a full display image may be projected onto waveguide display 580 and directed to user's eye 590 by waveguide display 580 in each scanning cycle. For example, in embodiments where light source 540 includes light emitters for all pixels in one or more rows or columns, scanning mirror 570 may be rotated in the column or row direction (e.g., x or y direction) to scan an image. In embodiments where light source 540 includes light emitters for some but not all pixels in one or more rows or columns, scanning mirror 570 may be rotated in both the row and column directions (e.g., both x and y directions) to project a display image (e.g., using a raster-type scanning pattern).

NED device 550 may operate in predefined display periods. A display period (e.g., display cycle) may refer to a duration of time in which a full image is scanned or projected. For example, a display period may be a reciprocal of the desired frame rate. In NED device 550 that includes scanning mirror 570, the display period may also be referred to as a scanning period or scanning cycle. The light generation by light source 540 may be synchronized with the rotation of scanning mirror 570. For example, each scanning cycle may include multiple scanning steps, where light source 540 may generate a different light pattern in each respective scanning step.

In each scanning cycle, as scanning mirror 570 rotates, a display image may be projected onto waveguide display 580 and user's eye 590. The actual color value and light intensity (e.g., brightness) of a given pixel location of the display image may be an average of the light beams of the three colors (e.g., red, green, and blue) illuminating the pixel location during the scanning period. After completing a scanning period, scanning mirror 570 may revert back to the initial position to project light for the first few rows of the next display image or may rotate in a reverse direction or scan pattern to project light for the next display image, where a new set of driving signals may be fed to light source 540. The same process may be repeated as scanning mirror 570 rotates in each scanning cycle. As such, different images may be projected to user's eye 590 in different scanning cycles.

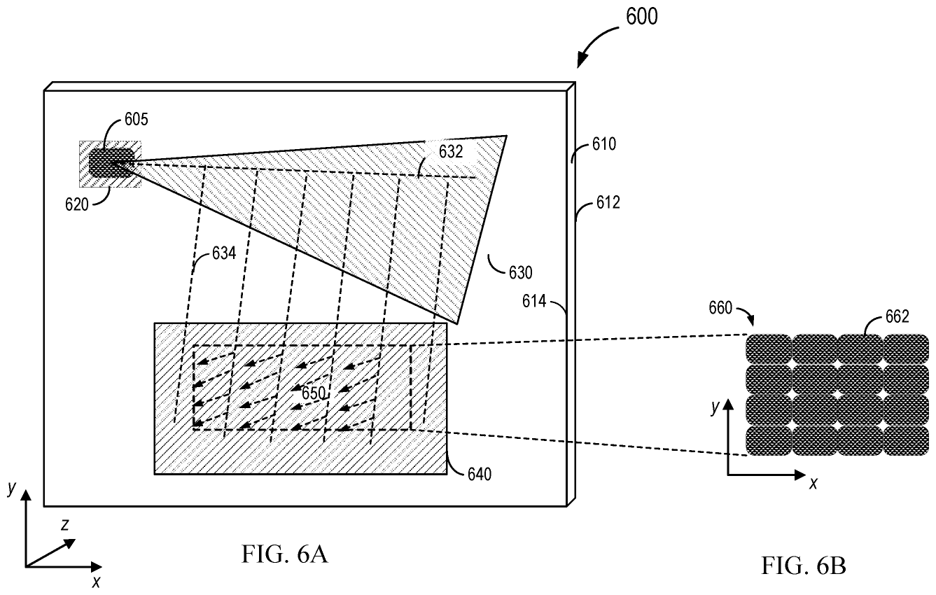

FIG. 6A illustrates an example of an optical see-through augmented reality system including a waveguide display 600 and surface-relief gratings for exit pupil expansion according to certain embodiments. Waveguide display 600 may include a substrate 610 (e.g., a waveguide), which may be similar to substrate 420. Substrate 610 may be transparent to visible light and may include, for example, a glass, quartz, plastic, polymer, PMMA, ceramic, Si₃N₄, or crystal substrate. Substrate 610 may be a flat substrate or a curved substrate. Substrate 610 may include a first surface 612 and a second surface 614. Display light may be coupled into substrate 610 by an input coupler 620, and may be reflected by first surface 612 and second surface 614 through total internal reflection, such that the display light may propagate within substrate 610. Input coupler 620 may include a grating, a refractive coupler (e.g., a wedge or a prism), or a reflective coupler (e.g., a reflective surface having a slant angle with respect to substrate 610). For example, in one embodiment, input coupler 620 may include a prism that may couple display light of different colors into substrate 610 at a same refraction angle. In another example, input coupler 620 may include a grating coupler that may diffract light of different colors into substrate 610 at different directions. Input coupler 620 may have a coupling efficiency of greater than 10%, 20%, 30%, 50%, 75%, 90%, or higher for visible light.

Waveguide display 600 may also include a first output grating 630 and a second output grating 640 positioned on one or two surfaces (e.g., first surface 612 and second surface 614) of substrate 610 for expanding incident display light beam in two dimensions in order to fill an eyebox with the display light. First output grating 630 may be configured to expand at least a portion of the display light beam along one direction, such as approximately in the x direction. Display light coupled into substrate 610 may propagate in a direction shown by a line 632. While the display light propagates within substrate 610 along a direction shown by line 632, a portion of the display light may be diffracted by a region of first output grating 630 towards second output grating 640 as shown by a line 634 each time the display light propagating within substrate 610 reaches first output grating 630. Second output grating 640 may then expand the display light from first output grating 630 in a different direction (e.g., approximately in the y direction) by diffracting a portion of the display light from an exit region 650 to the eyebox each time the display light propagating within substrate 610 reaches second output grating 640.

FIG. 6B illustrates an example of an eyebox including two-dimensional replicated exit pupils. FIG. 6B shows that a single input pupil 605 may be replicated by first output grating 630 and second output grating 640 to form an aggregated exit pupil 660 that includes a two-dimensional array of individual exit pupils 662. For example, the exit pupil may be replicated in approximately the x direction by first output grating 630 and in approximately the y direction by second output grating 640. As described above, output light from individual exit pupils 662 and propagating in a same direction may be focused onto a same location in the retina of the user's eye. Thus, a single image may be formed by the user's eye from the output light in the two-dimensional array of individual exit pupils 662.

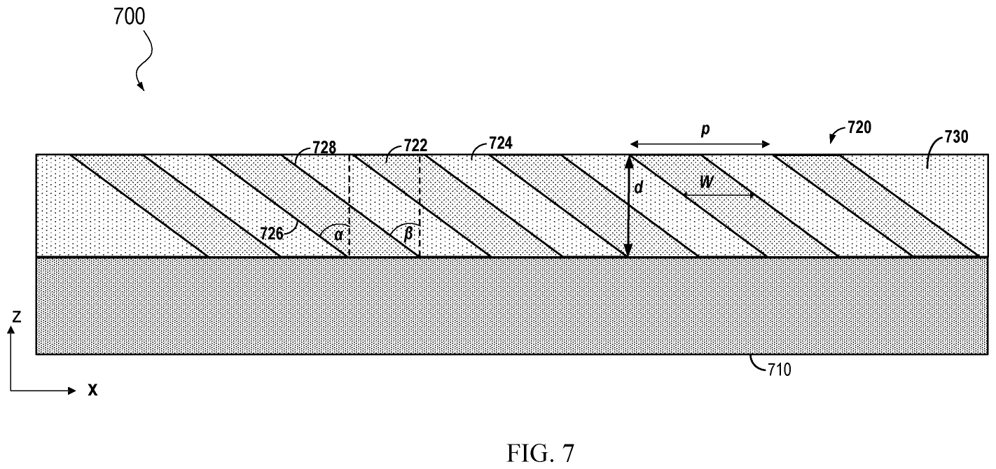

FIG. 7 illustrates an example of a slanted grating 720 in a waveguide display 700 according to certain embodiments. Slanted grating 720 may be an example of input coupler 430, output couplers 440, or grating couplers 620, 630, and 640. Waveguide display 700 may include slanted grating 720 on a waveguide 710, such as substrate 420, or substrate 610. Slanted grating 720 may act as a grating coupler for couple light into or out of waveguide 710. In some embodiments, slanted grating 720 may include a one-dimensional periodic structure with a period p. For example, slanted grating 720 may include a plurality of ridges 722 and grooves 724 between ridges 722. Each period of slanted grating 720 may include a ridge 722 and a groove 724, which may be an air gap or a region filled with a material with a refractive index n_{g2}. The ratio between the width d of a ridge 722 and the grating period p may be referred to as duty cycle. Slanted grating 720 may have a duty cycle ranging, for example, from about 10% to about 90% or greater. In some embodiments, the duty cycle may vary from period to period. In some embodiments, the period p of the slanted grating may vary from one area to another on slanted grating 720, or may vary from one period to another (i.e., chirped) on slanted grating 720.

Ridges 722 may be made of a material with a refractive index of n_{g1}, such as silicon containing materials (e.g., SiO₂, Si₃N₄, SiC, SiOₓN_{y}, or amorphous silicon), organic materials (e.g., spin on carbon (SOC) or amorphous carbon layer (ACL) or diamond like carbon (DLC)), or inorganic metal oxide layers (e.g., TiOₓ, AlOₓ, TaOₓ, HfOₓ, etc.). Each ridge 722 may include a leading edge 726 with a slant angle α and a trailing edge 728 with a slant angle β. In some embodiments, leading edge 726 and trailing edge 728 of each ridge 722 may be parallel to each other. In other words, slant angle α is approximately equal to slant angle β. In some embodiments, slant angle α may be different from slant angle β. In some embodiments, slant angle α may be approximately equal to slant angle β. For example, the difference between slant angle α and slant angle θ may be less than 20%, 10%, 5%, 1%, or less. In some embodiments, slant angle α and slant angle θ may range from, for example, about 30° or less to about 70% or larger.

In some implementations, grooves 724 between the ridges 722 may be over-coated or filled with an overcoat layer 730. Overcoat layer 730 may include a material having a refractive index n_{g2} higher or lower than the refractive index of the material of ridges 722. For example, in some embodiments, a high refractive index material, such as Hafnia, Titania, Tantalum oxide, Tungsten oxide, Zirconium oxide, Gallium sulfide, Gallium nitride, Gallium phosphide, silicon, and a high refractive index polymer, may be used to fill grooves 724. In some embodiments, a low refractive index material, such as silicon oxide, alumina, porous silica, or fluorinated low index monomer (or polymer), may be used to fill grooves 724. As a result, the difference between the refractive index of the ridges and the refractive index of the grooves may be greater than 0.1, 0.2, 0.3, 0.5, 1.0, or higher.

Slanted grating 720, as a diffractive optical element, may be wavelength dependent. For example, due to the different wavelength λ, light of different colors incident at a same incident angle may be diffracted at diffraction angles for the same diffraction order to satisfy the grating equation. Light of a same color from different fields of view may also be diffracted at different angles to satisfy the grating equation.

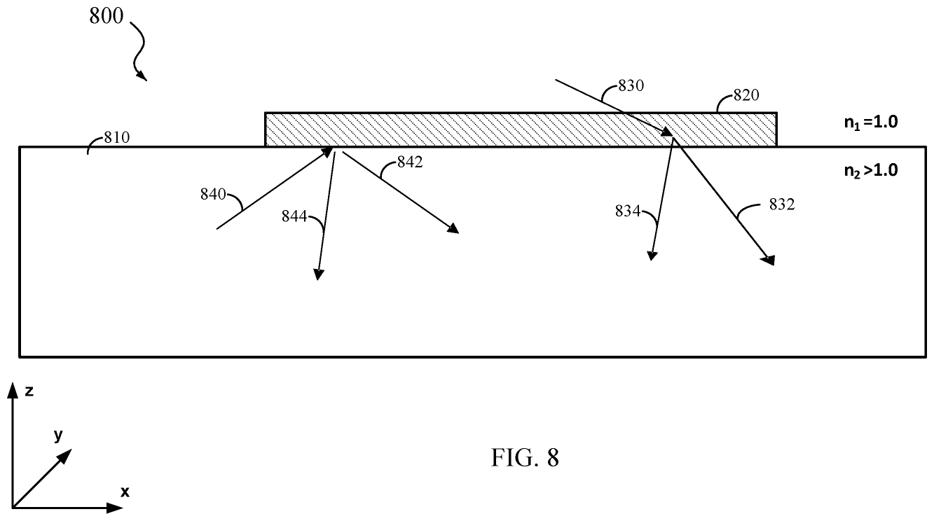

FIG. 8 illustrates propagations of display light 840 and external light 830 in an example waveguide display 800 including a waveguide 810 and a grating coupler 820. Waveguide 810 may be a flat or curved transparent substrate with a refractive index n₂ greater than the free space refractive index n₁ (e.g., 1.0). Grating coupler 820 may be, for example, a Bragg grating or a surface-relief grating.

Display light 840 may be coupled into waveguide 810 by, for example, input coupler 430 of FIG. 4 or other couplers (e.g., a prism or slanted surface) described above. Display light 840 may propagate within waveguide 810 through, for example, total internal reflection. When display light 840 reaches grating coupler 820, display light 840 may be diffracted by grating coupler 820 into, for example, a 0^{th} order diffraction (i.e., reflection) light 842 and a −1st order diffraction light 844. The 0^{th} order diffraction may propagate within waveguide 810, and may be reflected by the bottom surface of waveguide 810 towards grating coupler 820 at a different location. The −1st order diffraction light 844 may be coupled (e.g., refracted) out of waveguide 810 towards the user's eye, because a total internal reflection condition may not be met at the bottom surface of waveguide 810 due to the diffraction angle.

External light 830 may also be diffracted by grating coupler 820 into, for example, a 0^{th} order diffraction light 832 and a −1st order diffraction light 834. Both the 0^{th} order diffraction light 832 and the −1st order diffraction light 834 may be refracted out of waveguide 810 towards the user's eye. Thus, grating coupler 820 may act as an input coupler for coupling external light 830 into waveguide 810, and may also act as an output coupler for coupling display light 840 out of waveguide 810. As such, grating coupler 820 may act as a combiner for combining external light 830 and display light 840. In general, the diffraction efficiency of grating coupler 820 (e.g., a surface-relief grating coupler) for external light 830 (i.e., transmissive diffraction) and the diffraction efficiency of grating coupler 820 for display light 840 (i.e., reflective diffraction) may be similar or comparable.

In order to diffract light at a desired direction towards the user's eye and to achieve a desired diffraction efficiency for certain diffraction orders, grating coupler 820 may include a blazed or slanted grating, such as a slanted Bragg grating or surface-relief grating, where the grating ridges and grooves may be tilted relative to the surface normal of grating coupler 820 or waveguide 810.

### Layered Waveguides

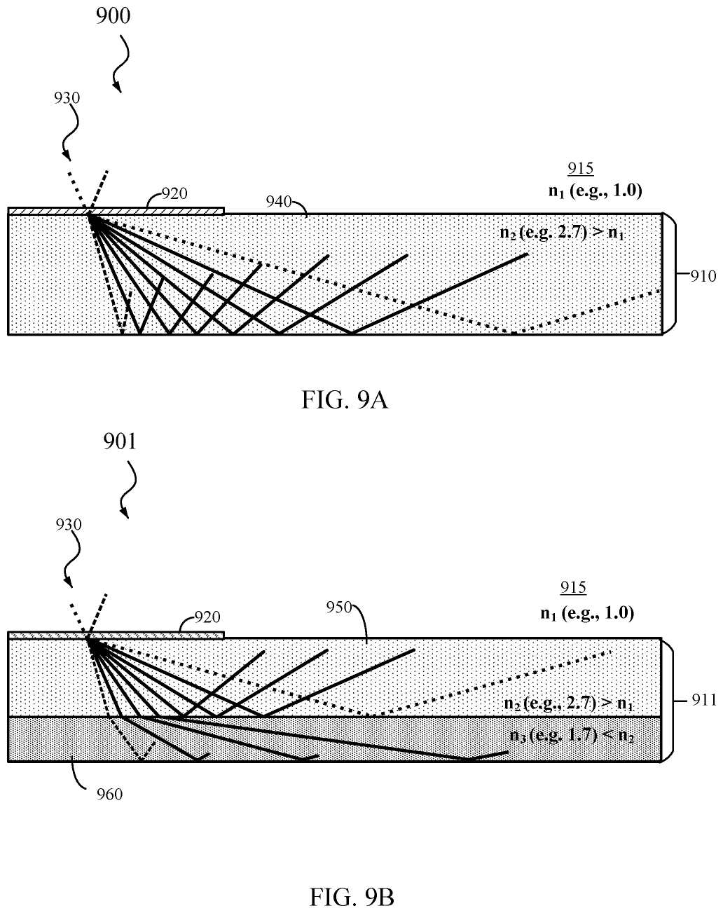

A layered waveguide (also referred to herein as a “multi-layer waveguide”) may include multiple waveguide layers of different refractive indices and/or thickness bonded together. In one example, a thick optical substrate is bonded to a base layer to form a two-layer waveguide stack. Having multiple waveguide layers may allow for selective coupling of certain wavelengths of light and/or angles of light through different layers of the layered waveguide. For example, a waveguide layer of lower refractive index material may be bonded to a base waveguide layer to couple blue light through the waveguide layer of lower refractive index material to increase brightness of the layered waveguide such as depicted in the example shown in FIG. 9B.

Having multiple bonded waveguide layers may also increase efficiency over a single-layer waveguide. For example, a layered waveguide may have improved brightness as compared with a single-layer waveguide by allowing for sparser replication of field-of-views (FOVs) that would have been denser in a single-layer waveguide as illustrated by comparing the single-layer waveguide 910 with the layered waveguide 911 shown in FIGS. 9A and 9B.

Uniformity in a layered waveguide such as layered waveguide 911 depicted in FIG. 9B may be limited by the dark lines in the field-of-view when rays propagate at near −90° angles in a low-index waveguide, which can be mitigated by using anisotropic media. For example, a layered waveguide having a thickness of 850 μm thick with a first layer of 500 μm thick SiC, a second layer of 350 μm thick glass, and a 5 μm thick LC layer (nₑ=1.65 and n₀=1.5) had 537 nits of brightness at a 6:1 uniformity.

FIG. 9A illustrates propagations of external light 930 in an example of a waveguide display 900 having a single-layer waveguide 910 and a grating coupler 920. Single-layer waveguide 910 may be flat or curved. Single-layer waveguide 910 includes a transparent waveguide layer 940 having a refractive index n₂ (e.g., 2.7) that is greater than the free space refractive index n₁ (e.g., 1.0). Grating coupler 920 may be, for example, a Bragg grating or a surface-relief grating. For simplicity, the illustrated example shows a single bounce of light at an interface between the transparent waveguide layer 940 and the surrounding free space 915. It would be understood that light may be bouncing multiple times at interfaces with the free space and/or transmitted to the free space 915.

Although not shown, in another implementation, display light may also be coupled into single-layer waveguide 910, for example, by one or more input couplers such as input coupler 430 of FIG. 4 or other couplers (e.g., a prism or slanted surface) described herein. Display light may propagate within single-layer waveguide 910 through, for example, total internal reflection. When display light reaches grating coupler 920, display light may be diffracted by grating coupler 920 into, for example, a 0^{th} order diffraction (i.e., reflection) light and a −1st order diffraction light. The 0^{th} order diffraction may propagate within single-layer waveguide 910, and may be reflected by the bottom surface of single-layer waveguide 910 towards grating coupler 920 at a different location. The −1st order diffraction light may be coupled (e.g., refracted) out of single-layer waveguide 910 towards the user's eye, because a total internal reflection condition may not be met at the bottom surface of single-layer waveguide 910 due to the diffraction angle.

External light 930 may also be diffracted by grating coupler 920 into, for example, a 0^{th} order diffraction light and a −1st order diffraction light. Both the 0^{th} order diffraction light and the −1st order diffraction light may be refracted out of single-layer waveguide 910 towards the user's eye. Thus, grating coupler 920 may act as an input coupler for coupling external light 930 into single-layer waveguide 910, and may also act as an output coupler for coupling display light out of single-layer waveguide 910. As such, grating coupler 920 may act as a combiner for combining external light 930 and display light. In general, the diffraction efficiency of grating coupler 920 (e.g., a surface-relief grating coupler) for external light 930 (i.e., transmissive diffraction) and the diffraction efficiency of grating coupler 920 for display light (i.e., reflective diffraction) may be similar or comparable.

In order to diffract light at a desired direction towards the user's eye and to achieve a desired diffraction efficiency for certain diffraction orders, grating coupler 920 may include a blazed or slanted grating, such as a slanted Bragg grating or surface-relief grating, where the grating ridges and grooves may be tilted relative to the surface normal of grating coupler 920 or single-layer waveguide 910.

FIG. 9B illustrates propagations of external light 930 in an example waveguide display 901 including a layered waveguide 911 and a grating coupler 920. Layered waveguide 911 may be flat or curved. Layered waveguide 911 includes a first transparent waveguide layer 950 having a refractive index n₂ (e.g., 2.7) greater than the free space refractive index n₁ (e.g., 1.0) and a second transparent waveguide layer 960 having a refractive index n₃. In this example, the second transparent waveguide layer 960 has a refractive index n₃ less than the refractive index n₂ such as, e.g., 1.7, to selectively couple, e.g., blue light, through the second transparent waveguide layer 960. Grating coupler 920 may be, for example, a Bragg grating or a surface-relief grating. For simplicity, the illustrated example shows a single bounce of light at interfaces between the first waveguide layer 950 and the second waveguide layer 960 and between the second waveguide layer 960 and the surrounding free space 915. It would be understood that light may be bouncing multiple times at the interfaces.

Although not shown, in another example, display light may also be coupled into layered waveguide 911, for example, by one or more input couplers such as input coupler 430 of FIG. 4 or other couplers (e.g., a prism or slanted surface) described herein. Display light may propagate within layered waveguide 911 through, for example, total internal reflection. When display light reaches grating coupler 920, display light may be diffracted by grating coupler 920 into, for example, a 0^{th} order diffraction (i.e., reflection) light and a −1st order diffraction light. The 0^{th} order diffraction may propagate within layered waveguide 911, and may be reflected by the bottom surface of layered waveguide 911 towards grating coupler 920 at a different location. The −1st order diffraction light may be coupled (e.g., refracted) out of layered waveguide 911 towards the user's eye, because a total internal reflection condition may not be met at the bottom surface of layered waveguide 911 due to the diffraction angle.

External light 930 may also be diffracted by grating coupler 920 into, for example, a 0^{th} order diffraction light and a −1st order diffraction light. Both the 0^{th} order diffraction light and the −1st order diffraction light may be refracted out of layered waveguide 911 towards the user's eye. Thus, grating coupler 920 may act as an input coupler for coupling external light 930 into layered waveguide 911, and may also act as an output coupler for coupling display light out of layered waveguide 911. As such, grating coupler 920 may act as a combiner for combining external light 930 and display light. In general, the diffraction efficiency of grating coupler 920 (e.g., a surface-relief grating coupler) for external light 930 (i.e., transmissive diffraction) and the diffraction efficiency of grating coupler 920 for display light (i.e., reflective diffraction) may be similar or comparable.

In order to diffract light at a desired direction towards the user's eye and to achieve a desired diffraction efficiency for certain diffraction orders, grating coupler 920 may include a blazed or slanted grating, such as a slanted Bragg grating or surface-relief grating, where the grating ridges and grooves may be tilted relative to the surface normal of grating coupler 920 or layered waveguide 911.

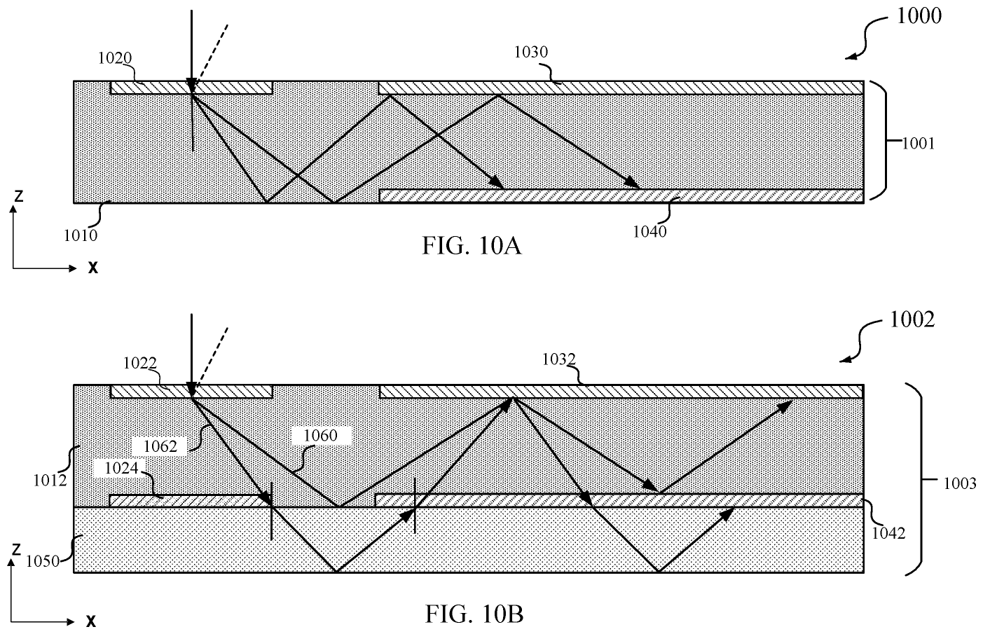

FIG. 10A illustrates an example of a waveguide display 1000 with a single-layer waveguide 1001. Waveguide display 1000 includes a substrate 1010 of transparent material, which may be similar to substrate 420, substrate 610, or waveguide 710. Substrate 1010 may include, for example, glass, silicon, silicon nitride, silicon carbide, LiNbO₃, TiO₂, GaN, SiC, CVD diamond, ZnS, or any other suitable material. An input grating 1020 and one or more output gratings 1030 and 1040 may be etched in substrate 1010 or in a grating material layer formed on substrate 1010. Input grating 1020 and output gratings 1030 and 1040 may include slanted or vertical surface-relief gratings, and may include an overcoat layer filling the grating grooves as described above. Output gratings 1030 and 1040 may be etched on opposite surfaces of substrate 1010. In some embodiments, only one output grating 1030 or 1040 may be used. As described above with reference to, for example, FIGS. 4 and 6A, input grating 1020 may couple display light of different colors (e.g., red, green, and/or blue) from different view angles (or within different FOVs) into substrate 1010, which may guide the in-coupled display light through total internal reflection. A portion of the in-coupled display light propagating within substrate 1010 may be coupled out of substrate 1010 towards an eyebox of waveguide display 1000 by output grating 1030 or 1040 each time the in-coupled display light reaches output grating 1030 or 1040.

As described above, to satisfy the grating equation, light of different colors (wavelengths) and/or from different view angles may have different diffraction angles. For example, in the example illustrated in FIG. 10A, two light beams having different colors (e.g., red and blue) and the same incidence angle (e.g., about 0°) may be diffracted by input grating 1020 to different directions within substrate 1010. More specifically, the light beam having a shorter wavelength (e.g., blue light) may have a smaller diffraction angle. Two light beams having the same color but different incidence angles may also be diffracted by input grating 1020 to two different directions within substrate 1010. Due to the different propagation directions, the two in-coupled light beams may reach the surfaces of substrate 1010 after propagating different distances in the x direction. Therefore, a light beam having a smaller angle with respect to the surface-normal direction of substrate 1010 may reach output grating 1030 or 1040 for a larger number of times than a light beam having a larger angle with respect to the surface-normal direction of substrate 1010. As such, display light of different colors or from different FOVs may be directed to the eyebox at different densities, and thus display light of different colors or from different FOVs may not be uniformly directed to the user's eyes.

According to certain embodiments, to improve uniformity of a display for light of all colors and from all FOVs, a layered waveguide may be implemented. A layered waveguide may include waveguide layers having different desired refractive indices and/or thicknesses. In one implementation, the plurality of waveguide layers in a layered waveguide stack may have a waveguide layer with the highest refractive index at the center of the layer stack, and the refractive indices of the waveguide layers in the stack may decrease from the center outward towards the two opposing outer sides of the layer stack. In some embodiments, the refractive indices of the waveguide layers may decrease going from one side to the opposite side of the layer stack.

FIG. 10B illustrates an example of a layered waveguide display 1002 with a layered waveguide 1003 according to certain embodiments. Multi-layer waveguide display 1002 includes a substrate (also referred to as a “first waveguide layer”) 1012 of a transparent material, input gratings 1022 and 1024, and output gratings 1032 and 1042, which may be similar to substrate 1010, input grating 1020, and output gratings 1030 and 1040, respectively. Input gratings 1022 and 1024 and output gratings 1032 and 1042 may be formed in first waveguide layer 1012 or may be a grating material layer formed on first waveguide layer 1012. In one example, input gratings 1022 and 1024 and/or output gratings 1032 and 1042 may be vertical or slanted surface-relief gratings formed in first waveguide layer 1012 or a grating material layer formed on first waveguide layer 1012, and/or may include an overcoat layer filling the grating grooves. Multi-layer waveguide display 1002 also includes a second waveguide layer 1050, which may be, for example, a thin layer (e.g., a few hundred micrometers, such as between about 100 μm and about 600 μm) of a transparent material having a lower refractive index than the refractive index of first waveguide layer 1012. In some implementations, the difference between the refractive index of first waveguide layer 1012 and the refractive index of second waveguide layer 1050 may be about 0.1, 0.2, 0.25, 0.3, or larger.

In the example shown in FIG. 10B, a first light beam 1060 (e.g., having a longer wavelength or from a larger view angle) may be coupled into first waveguide layer 1012 by input grating 1022 and may propagate within first waveguide layer 1012 with a large angle with respect to a surface-normal direction of first waveguide layer 1012. Therefore, first light beam 1060 may be reflected at the interface first waveguide layer first waveguide layer 1012 and second waveguide layer 1050 through total internal reflection, due to the large incidence angle and the large difference between the refractive indices of first waveguide layer 1012 and second waveguide layer 1050. A second light beam 1062 (e.g., having a shorter wavelength and/or from a smaller view angle) may be coupled into first waveguide layer 1012 by input grating 1022 and may propagate within first waveguide layer 1012 with a smaller angle with respect to the surface-normal direction of first waveguide layer 1012. Therefore, second light beam 1062 may not be reflected at the interface between first waveguide layer 1012 and second waveguide layer 1050 through total internal reflection, due to the small incidence angle. Thus, second light beam 1062 may instead be refracted at the interface with a larger refraction angle into second waveguide layer 1050, and may then be reflected at the bottom surface of second waveguide layer 1050 through total internal reflection due to the increased incidence angle and the larger difference (e.g., about 0.5) between the refractive indices of second waveguide layer 1050 and air. Therefore, even though second light beam 1062 may have a smaller propagation angle with respect to the surface-normal direction of first waveguide layer 1012 than first light beam 1060, second light beam 1062 may travel a longer distance in the z direction before being reflected through total internal reflection, and thus may travel a similar distance in the x direction as first light beam 1060 before being reflected through total internal reflection. In this way, first light beam 1060 and second light beam 1062 may be diffracted by output grating 1032 or 1042 for about the same number of times at about the same interval to improve the uniformity. The thicknesses and refractive indices of first waveguide layer 1012 and second waveguide layer 1050 can be selected to achieve the desired performance.

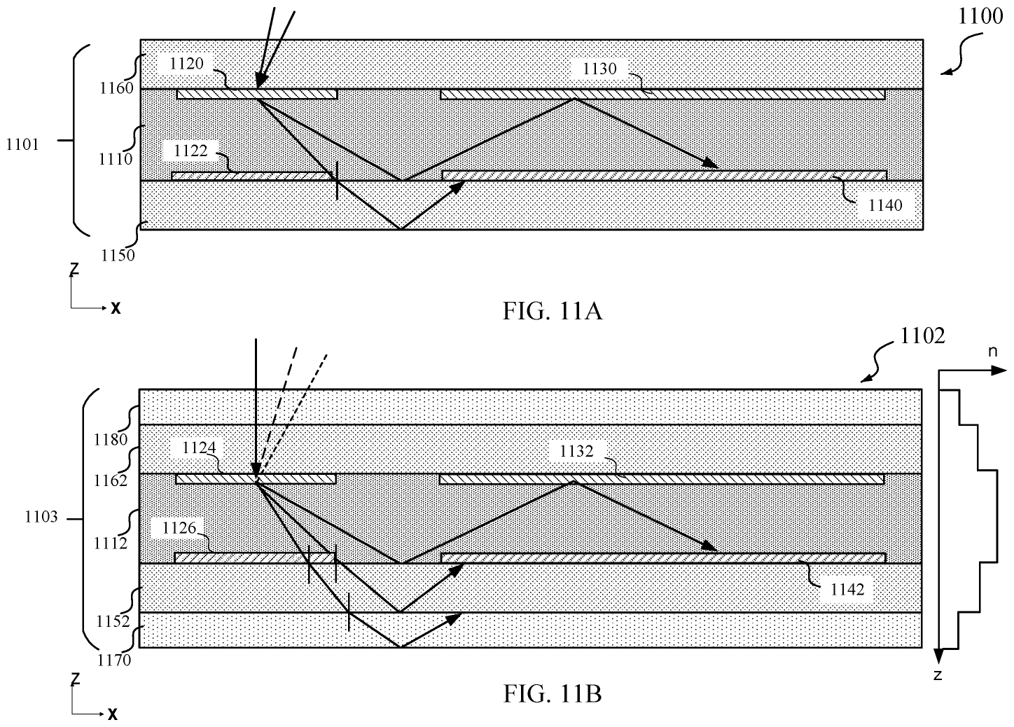

FIG. 11A illustrates an example of a multi-layer waveguide display 1100 including a layered waveguide 1101 according to certain embodiments. Multi-layer waveguide display 1100 may include a first waveguide layer with one or more input gratings and/or one or more output gratings. In FIG. 11A, multi-layer waveguide display 1100 includes a first waveguide layer 1110 with input gratings 1120 and 1122 and output gratings 1130 and 1140 formed in the in first waveguide layer 1012 or a grating material layer formed on first waveguide layer 1012 similar to waveguide display 1000 and multi-layer waveguide display 1002 described above. First waveguide layer 1110 may include, for example, glass, silicon, silicon nitride, silicon carbide, LiNbO₃, TiO₂, GaN, AlN, SiC, CVD diamond, ZnS, and the like. Input gratings 1120 and 1122 and/or output gratings 1130 and 1140 may be slanted or vertical surface-relief gratings and may include an overcoat layer filling the grating grooves. Multi-layer waveguide display 1100 also includes a second waveguide layer 1150 and a third waveguide layer 1160 on opposing sides of first waveguide layer 1110. Second waveguide layer 1150 and third waveguide layer 1160 may each be a thin layer (e.g., a few hundred micrometers, such as between about 100 μm and about 600 μm) of a transparent material having a lower refractive index than the refractive index of first waveguide layer 1110. For example, the difference between the refractive index of first waveguide layer 1110 and the refractive index of second waveguide layer 1150 or third waveguide layer 1160 may be about 0.1, 0.2, 0.25, 0.3, or larger. Multi-layer waveguide display 1100 may achieve a more uniform replication of light having different colors and/or from different FOVs as described above with respect to FIG. 10B. The thicknesses and the refractive indices of first waveguide layer 1110, second waveguide layer 1150, and third waveguide layer 1160 may be selected to achieve the desired performance.

FIG. 11B illustrates another example of a multi-layer waveguide display 1102 including a layered waveguide 1103 according to certain embodiments. Multi-layer waveguide display 1102 may include a first waveguide layer with one or more input gratings and one or more output gratings. In FIG. 11B, multi-layer waveguide display 1102 includes a first waveguide layer 1112 with input gratings 1124 and 1126 and output gratings 1132 and 1142 formed thereon as in waveguide display 1000 and multi-layer waveguide display 1002 or 1100 described above. First waveguide layer 1112 may include, for example, glass, silicon, silicon nitride, silicon carbide, LiNbO₃, TiO₂, GaN, AlN, SiC, CVD diamond, ZnS, and the like. Input gratings 1124 and 1126 and output gratings 1132 and 1142 may be slanted or vertical surface-relief gratings and may include an overcoat layer filling the grating grooves as described above with respect to, for example, FIG. 7. Multi-layer waveguide display 1102 also includes a second waveguide layer 1152 and a third waveguide layer 1162 on opposing sides of first waveguide layer 1112. Second waveguide layer 1152 and third waveguide layer 1162 may each be, for example, a thin layer (e.g., a few hundred micrometers, such as between about 100 μm and about 600 μm) of a transparent material having a lower refractive index than the refractive index of first waveguide layer 1112. In one example, the difference between the refractive index of first waveguide layer 1112 and the refractive index of second waveguide layer 1152 or third waveguide layer 1162 may be about 0.1, 0.2, 0.25, 0.3, or larger. Second waveguide layer 1152 and third waveguide layer 1162 may have the same refractive index or different refractive indices and/or may have the same thickness or different thicknesses.

In addition, a fourth waveguide layer may be formed on second waveguide layer 1152 and a fifth waveguide layer may be formed on third waveguide layer 1162. In FIG. 11B, multi-layer waveguide display 1102 includes a fourth waveguide layer 1170 disposed adjacent second waveguide layer 1152 and a fifth waveguide layer 1180 disposed adjacent third waveguide layer 1162. Fourth waveguide layer 1170 and fifth waveguide layer 1180 may each be, for example, a thin layer (e.g., a few hundred micrometers, such as between about 100 μm and about 600 μm) of a transparent material having a lower refractive index than the refractive indices of second waveguide layer 1152 and third waveguide layer 1162, respectively. In one example, the difference between the refractive index of second waveguide layer 1152 and the refractive index of fourth waveguide layer 1170 and the difference between the refractive index of third waveguide layer 1162 and the refractive index of fifth waveguide layer 1180 may be about 0.1, 0.2, 0.25, 0.3, or larger. Fourth waveguide layer 1170 and fifth waveguide layer 1180 may have the same refractive index or different refractive indices and/or may have the same thickness or different thicknesses. Multi-layer waveguide display 1102 may achieve a more uniform replication of light having different colors and from different FOVs as described above with respect to FIG. 8B. The thicknesses and/or the refractive indices of first waveguide layer 1112, second waveguide layer 1152, third waveguide layer 1162, fourth waveguide layer 1170, and fifth waveguide layer 1180 may be selected to achieve a desired performance.

While the illustrated examples of waveguide stacks 1100 and 1102 in FIGS. 11A and 11B show layered waveguide 1101 having three waveguide layers 1110, 1150, 1160 and layered waveguide 1102 having five waveguide layers 1112, 1152, 1162, 1170, 1180, in other implementations fewer or additional waveguide layers may be included. For example, in one implementation, multi-layer waveguide display 1100 in FIG. 11A may not include either second waveguide layer 1150 or third waveguide layer 1160. As another example, in one implementation, multi-layer waveguide display 1102 may not include either waveguide layers 1162 and 1180 or waveguide layers 1152 and 1170.

In various embodiments, a multi-layer waveguide display disclosed herein may include a layered waveguide having two or more waveguide layers, such as three, four, five, or more layers. In some embodiments, the waveguide layers with the lowest refractive indices (also referred to as low-index waveguide layers) may be located on the same side with input and output gratings and the waveguide layers with highest refractive index (also referred to as high-index waveguide layers) may be located on the opposing side of the layer stack. For example, the waveguide layers may be arranged in the waveguide stack to decrease in refractive index from one side to the opposing side of the layer stack, e.g., with waveguide layers having the lowest refractive indices located on a side having input and output gratings. In another example, the waveguide layers with lowest refractive indices may be located on opposing sides of the layer stack. For example, the waveguide layers may be arranged in the waveguide stack with the waveguide layer having the highest refractive index at the center of the stack and then arranging the other waveguide layers to decrease (e.g., gradually decrease) in refractive index toward the opposing sides of the layer stack. In some cases, the refractive index profile of the waveguide layer stack may be symmetrical and have the highest value at the center of the layer stack such as. For example, with reference to the stack shown in FIG. 11B, first waveguide layer 1112 at the center of the stack may have the highest refractive index in the stack, third waveguide layer 1162 may have a refractive index lower than first waveguide layer 1112, fifth waveguide layer 1180 may have a refractive index lower than third waveguide layer 1162, second waveguide layer 1152 may have a refractive index lower than first waveguide layer 1112, and/or fourth waveguide layer 1170 may have a refractive index lower than second waveguide layer 1152. In other cases, the refractive index profile of the waveguide layer stack may not be symmetrical with respect to the center of the waveguide layer stack.

The multiple waveguide layers having different refractive indices and thicknesses (e.g., 100 or 200 μm) may need to be flat and have a low total thickness variation (e.g., <1 μm) or surface roughness (e.g., with a root mean squared areal roughness less than about 1 nm). The multiple waveguide layers may need to have low transmissive haze, and would not need to be polished. It may also be desirable that the multiple waveguide layers be fabricated at low temperatures, such as at room temperature. Thus, it can be challenging to fabricate the multiple waveguide layers on a substrate that has grating couplers etched thereon. The multi-layer waveguide may be made by bonding multiple low-index substrates or layers to a substrate (e.g., a SiC substrate), by lamination, by slot-die coating, by chemical vapor deposition (e.g., PECVD), or the like. However, these techniques may not be able to achieve the desired characteristics of the multiple waveguide layers.

### Inkjet 3-D Printing

According to certain embodiments, a multi-layer (layered) waveguide may be fabricated using one or more inkjet 3-D printing techniques. During inkjet 3-D printing, a number of small drops of a resin material (sometimes referred to herein as an ink) may be deposited on a substrate having input and output gratings formed thereon. The number of small drops of the resin material (e.g., in the form of a two-dimensional array) may form a uniform thin layer (e.g., about 10 μm), which may be cross-linked, for example, through ultraviolet (UV) curing or thermal treatment. One or more additional thin layers of the resin material may be deposited on the first cross-linked thin layer and cross-linked, until the desired total thickness of a waveguide layer is achieved. Another waveguide layer, e.g., having a different (e.g. lower) refractive index, may be printed on the already printed waveguide layer (e.g., with a higher refractive index than the other waveguide layer) or may be printed on a side of the waveguide layer stack opposing the already printed waveguide layer.

Using 3-D printing techniques disclosed herein, material can be deposited only on selected areas of interest, such as only on top of the functional devices (e.g., the output gratings). Only one dicing operation may be needed to form individual devices from a base wafer with the one or more waveguide layers deposited thereon. There is no need to dice both the base wafer and other substrate(s) and then bond them together. The materials used in 3-D printing techniques can have a lower density (e.g., about 1.25 g/cm³) than, for example, a SiC substrate (e.g., about 3.21 g/cm³), fused silica (e.g., about 2.17 g/cm³), or other substrate materials. Thus, a waveguide display fabricated using 3-D printing may have a lighter weight than a waveguide display made by other deposition techniques. In addition, the material used for the 3-D printing can be tuned to have a desired refractive index. For example, high-index nanoparticles may be added to the resin material to tune the refractive index of the resin material. In one implementation, for example, high-index nanoparticles may be added to resin material to increase the refractive index of resin material from about 1.45 or lower to about 2.0 or higher. In another implementation, high-index nanoparticles may be added to resin material to increase the refractive index of resin material from about 1.45 or lower to between about 1.5 and about 1.8.

In some embodiments, the materials used for the inkjet 3-D printing techniques may include a base resin that has at least one actinic light curable moiety chosen from the groups comprising acrylates, epoxides, vinyls, thiols, allyls, vinylethers, allylethers, epoxyacrylates, urethane acrylates, and polyester acrylates. The materials used for the inkjet 3-D printing may also include a photoinitiator, such as a photo radical generator (PRG) or a photo acid generator. Nanoparticles used to tune the refractive index of a resin material may include metal oxides, such as titanium oxide, zirconium oxide, hafnium oxide, tungsten oxide, zinc tellurium, gallium phosphide, a derivative of any of the preceding materials, or any combination of these materials.

### Methods of Fabricating Layered (Multi-Layer) Waveguides

Generally speaking, a multi-layer waveguide is fabricated by bonding multiple waveguide layers together. For example, an optically-clear adhesive (OCA) or other bonding material may be used to bond one or more waveguide layers to a base waveguide layer having one or more waveguide dies disposed thereon to form a bonded waveguide stack. One or more individual waveguides may be cut from the bonded waveguide stack in a dicing process.

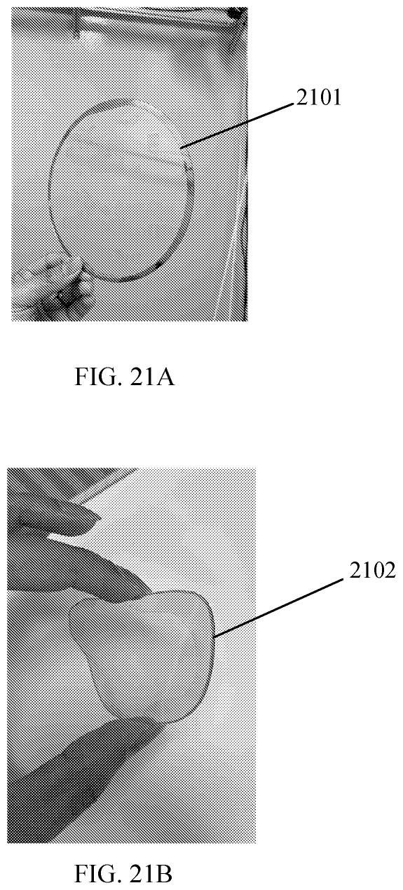

Methods of fabricating multi-layer waveguides may use a dicing operation that implements laser ablation or a like process to cut through the bonded waveguide stack to singulate individual waveguides. Laser ablation may implement a high-powered laser to repeatedly remove material in an region to scribe through the multiple layers of the waveguide stack. If a bonding material (e.g., optically clear adhesive) is present at the edges of the waveguide dies during the dicing operation, the laser ablation or other like destructive process may reduce the bonding strength of the bonding material at the edges of the individual waveguides. Certain bonding processes can cause residual stress in the bonding material layer due to, for example, polymerization shrinkage during an ultraviolet (UV) curing process or due to coefficient of thermal expansion (CTE) mismatches during a thermal bonding process. In certain instances, to relieve residual stress in the bonding material layer, a delamination front may start at the edges of the waveguides where the bonding strength of the bonding layer may have been degraded during the dicing process. This delamination front may then propagate inward over time causing delamination between waveguide layers. FIG. 21A depicts an example of a waveguide stack 2101 before a dicing operation. FIG. 21B depicts a multi-layer waveguide 2102 with delamination at its edges after a dicing operation. In the example shown in FIG. 21B, the dicing operation was performed on a bonded waveguide stack with one or more waveguide dies where a bonding material was present at the edges of the one or more waveguide dies during the dicing operation.

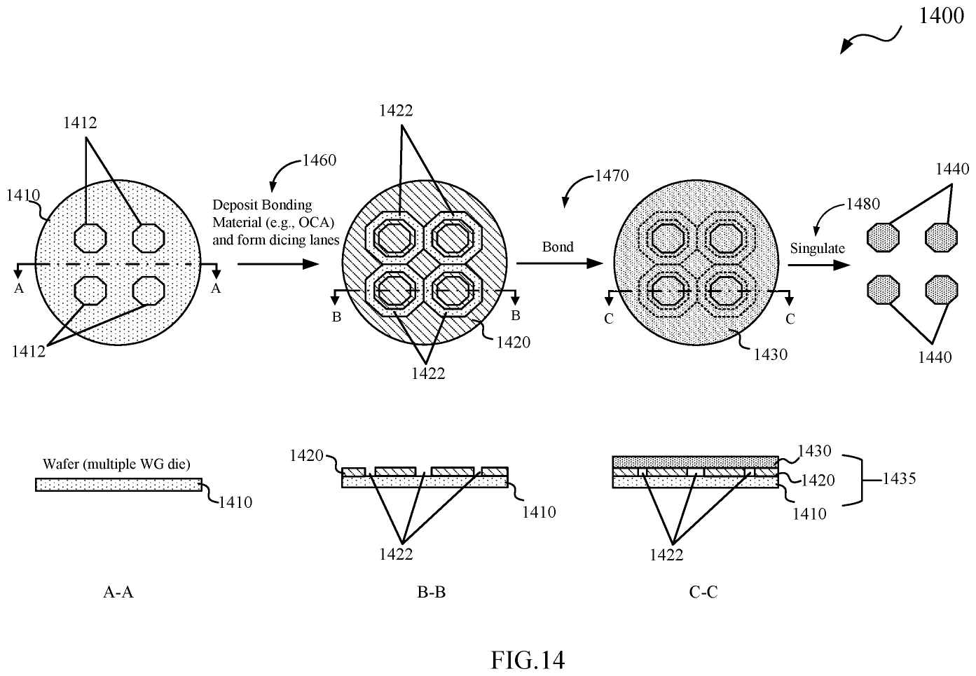

Some examples of methods of fabricating layered waveguides described herein form a bonded waveguide stack that may be free (or substantially free such as more than 90% free or more than 99% free) of bonding material in one or more dicing lines located around (e.g., circumscribing), or above, respective waveguide dies. Some of these examples are described below with reference to FIGS. 14-19.

In certain implementations, a layered waveguide is formed in part by selectively dispensing (e.g., by inkjet deposition) an optically-clear adhesive (OCA) material or other bonding material, and curing the bonding material after bonding the waveguide layer by exposing the bonding material to ultraviolet (UV) light and/or a thermal process. The OCA material or other bonding material may be a blend of a relatively low molecular weight monomer that can be exposed to UV light after bonding. The OCA material or other bonding material may have one or more of the properties including (i) being flowable as a neat material for good contact during bonding, (ii) crosslinkable after bonding with an appropriate photoinitiator (e.g., cationic, anionic, radical), (iii) low optical loss including haze and absorption, (iv) a high refractive index (e.g., greater than 1.5 or greater than 1.6), (v) good adhesion/wetting characteristics (contains hydrogen bonding/polar groups), and (vi) good bond strength in crosslinked state. In these implementations, the first (base) waveguide layer may have a base material that includes one or more of siloxanes, silsesquioxanes, (thio)urethanes, amides, (thio)ureas, (thio)carbonates, (thio)phosphates, aromatics (fluorenes, biphenyls, benzodithiophenes, and the like). In some cases, monomer functionalities may be added to the base material including one or more of (i) radical (meth)acrylates, acrylamides, styrenes, vinyl carbonyls, vinylcyclopropanes, and the like or (ii) a ring-opening material such as cyclic ethers (e.g., epoxides, oxetanes, and the like) cyclic carbonyls (e.g., carbonates, lactones, and the like). In one example, the base material is 67% fluorene diacrylate, 30% glycidyl POSS, 3% PAG (365 nm). In another example, the base material is 20-60 wt % solids in solvent (PGMEA).

In certain implementations, the optically-clear adhesive material or other bonding material may have a refractive index that is lower than the refractive index of one or more layers of the waveguide stack. For example, the optically-clear adhesive material or other bonding material may have a refractive index that is lower than the refractive index of the waveguide layer having the lowest refractive index (also sometimes referred to as a lowest refractive index layer) in the waveguide stack. In one example, the refractive index of the lowest refractive index layer is 1.7 and the refractive index of the OCA material or other bonding material is 1.6. In another example, the refractive index of the lowest refractive index layer is 1.7 and the refractive index of the OCA material or other bonding material is 1.5.

In certain implementations, a layered waveguide is formed in part by thermal bonding the optically-clear adhesive material or other bonding material and selectively patterning the layer of bonding material to remove material, e.g., removing material at one or more dicing lanes. In some cases, the optically-clear adhesive material or other bonding material may include high molecular weight, thermoplastic polymers, which can be melted for thermal bonding and cooled afterward to increase bond strength. The optically-clear adhesive material or other bonding material may have one or more of the properties including (i) low Tg for thermal bonding (e.g., <150 C or less than 100 C preferably), (ii) photopatternable in positive-tone or negative-tone development process, (iii) crosslinkable after bonding with appropriate chemical process (e.g., cationic, anionic, radical, thermal), (iv) low optical loss including haze and absorption, (v) high refractive index (e.g., greater than 1.5 or greater than 1.6), and (vi) good bond strength in crosslinked state (e.g., tunable MW, crosslinkable). In some cases, the first waveguide layer (sometimes referred to as a base waveguide layer) may have a base material that includes one or more of siloxanes, silsesquioxanes, (thio)urethanes, amides, (thio)ureas, (thio)carbonates, (thio)phosphates, aromatics (fluorenes, biphenyls, benzodithiophenes, and the like. Monomer functionalities may be added to the base material including one or more of (i) radical (meth)acrylates, acrylamides, styrenes, vinyl carbonyls, vinylcyclopropanes or (ii) a ring-opening material such as cyclic ethers (epoxides, oxetanes, etc.) cyclic carbonyls (carbonates, lactones, etc.). In one example, the base material is 30 kDa copolymer containing 30% tert-butyl methacrylate, 50% biphenyl methacrylate, and 20% glycidyl methacrylate. In another example, the base material is 20% solids (97% polymer: 3% PAG) in PGMEA solvent.

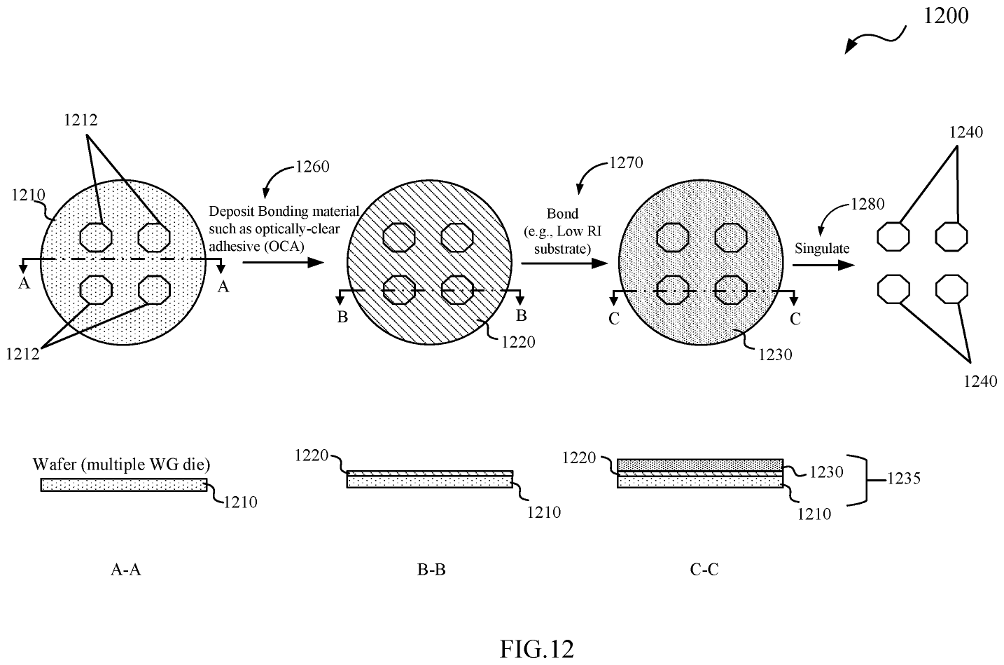

FIG. 12 is a diagram 1200 illustrating an example of a process flow depicting operations of a method of fabricating a layered waveguide, according to certain embodiments. The operations described in diagram 1200 are for illustration purposes only and are not intended to be limiting. In various implementations, modifications may be made to diagram 1200 to add additional operations, omit some operations, or change the order of the operations. One or more operations described in diagram 1200 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (RIE)) system, and the like.

FIG. 12 depicts a first (base) waveguide layer 1210 (e.g., a wafer of glass, silicon, silicon nitride, silicon carbide, LiNbO₃, TiO₂, GaN, AlN, SiC, CVD diamond, ZnS, etc.) having one or more waveguide dies 1212. At operation 1260, an optically-clear adhesive (OCA) material layer or other bonding material layer 1220 is deposited on the first waveguide layer 1210.

At operation 1270, a second waveguide layer 1230 such as a low refractive index substrate or other layer is bonded onto the first waveguide layer 1210 optically-clear adhesive (OCA) material layer or other bonding material layer 1220 in a bonding process to form a waveguide stack 1235. The bonding process may include an ultraviolet (UV) curing and/or a thermal bonding process.

At operation 1280, a dicing process is performed to form one or more individual waveguide devices 1240 (e.g., one, two, three, four, five, or more waveguide devices) from the waveguide stack 1235. In the illustrated example, four waveguide devices 1240 are formed from the waveguide stack 1235. The dicing process may include laser ablation or other like technique for cutting through the waveguide stack 1235. In certain cases, the first waveguide layer 1210 may have a higher refractive index than the second waveguide layer 1230 to cause a refractive index modulation.

Although not shown, the method of fabricating the multi-layer waveguide shown in FIG. 12, may also include one or more operations (e.g., by etching) for forming one or more input gratings and/or output gratings on the first waveguide layer 1210. The input gratings and output gratings may include, e.g., slanted or vertical surface-relief gratings.

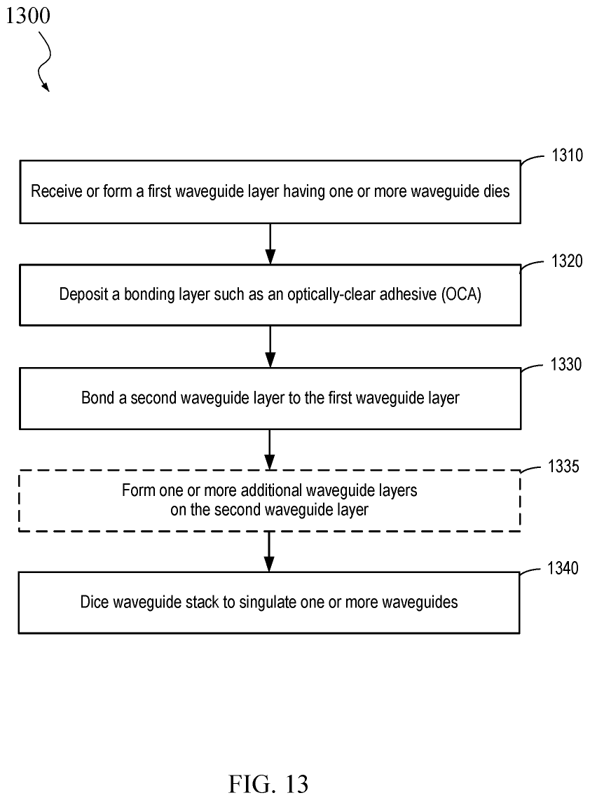

FIG. 13 includes a flowchart 1300 depicting an example of operations in a method of fabricating a multi-layer waveguide, according to certain embodiments. Certain operations may be similar to those depicted in FIG. 12. The operations shown in flowchart 1300 are for illustration purposes only and are not intended to be limiting. In various implementations, modifications may be made to flowchart 1300 to add additional operations, omit some operations, or change the order of the operations. The operations described in flowchart 1300 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (RIE)) system, and the like.

At operation 1310, a first waveguide layer (e.g., a wafer of glass, silicon, silicon nitride, silicon carbide, LiNbO₃, TiO₂, GaN, AlN, SiC, CVD diamond, ZnS, etc.) having one or more waveguide dies is received or formed. The first waveguide layer may have one or more input gratings and/or output formed thereon.

At operation 1320, an optically-clear adhesive (OCA) material layer or other bonding layer is deposited on the first waveguide layer.

At operation 1330, a second waveguide layer is bonded, in a bonding process, onto the first waveguide layer with a bonding layer such as an OCA material. The bonding process may include ultraviolet curing and/or thermal bonding process.

At optional (depicted by dashed line) operation 1335, one or more additional waveguide layers are bonded to the second waveguide layer to supplement the waveguide stack. For example, each additional waveguide layer may be formed on the waveguide stack by depositing an additional bonding layer and, in a bonding step, bonding the respective additional waveguide layer. In certain aspects, the first waveguide layer may have a higher refractive index than the second waveguide layer and/or other additional waveguide layers in the stack to cause refractive index modulation at each interface. For example, the refractive indices of the multiple waveguide layers may decrease from the first waveguide layer through subsequent bonded waveguide layers. In certain instances, the materials and thicknesses of the waveguide layers in the stack may selectively couple wavelengths of light through layers in the waveguides.

At operation 1340, a dicing process is performed to cut through the bonded waveguide stack to form one or more individual waveguide devices. The dicing process may include laser ablation or other like technique for cutting through the waveguide stack.

Methods of Fabricating Layered Waveguides with Selective Deposition/Removal

In certain implementations, methods of fabricating layered waveguides may remove or avoid forming adhesive material or other bonding material in one or more dicing lanes in the bonded waveguide stack where dicing is to occur. In this way, properties of the bonding material layer may not be affected by the dicing process and delamination due to degraded bonding strength resulting from laser ablation or other similar operation occurring during the dicing process may be avoided. These methods of fabricating layered waveguides may form a bonded waveguide stack that may be free (or substantially free such as more than 90% free or more than 99% free) of bonding material in one or more dicing lines around respective waveguide dies.

FIG. 14 includes a diagram 1400 illustrating an example of a process flow depicting operations of a method of fabricating a layered waveguide, according to embodiments. The operations dep in diagram 1400 are for illustration purposes only and are not intended to be limiting. In various implementations, modifications may be made to diagram 1400 to add additional operations, omit some operations, or change the order of the operations. One or more operations described in diagram 1400 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (RIE)) system, and the like.

FIG. 14 depicts a first waveguide layer 1410 (e.g., a wafer of glass, silicon, silicon nitride, silicon carbide, LiNbO₃, TiO₂, GaN, AlN, SiC, CVD diamond, ZnS, etc.) having one or more waveguide dies 1412. At operation 1460, an optically-clear adhesive material layer or other bonding material layer 1420 of, for example, a transparent bonding material, is deposited on the first waveguide layer 1410 and one or more dicing lanes 1422 are formed in the bonding layer 1420. In certain implementations, the one or more dicing lanes 1422 may be formed as part of an additive process of depositing the bonding material in areas of the first waveguide layer 1410 outside of the one or more dicing lanes 1422 using depositing techniques described herein. For example, an inkjet process or a drop cast process may be used to selectively deposit bonding material (e.g., an OCA material) on areas of the first waveguide layer 1410 outside of the one ore more dicing lanes 1422. In this example, the one or more dicing lanes 1422 may be kept free or substantially free of the bonding material. In other implementations, a subtractive process may be used to remove material at the one or more dicing lanes 1422 exposing the first waveguide layer 1410. For example, the bonding layer 1420 may be deposited such as, e.g., by spin coating, and an etching process such as lithographic process may be employed to remove material from the one or more dicing lanes 1422. Before the etching process, a mask layer may be patterned on the first waveguide layer 1410 with the dicing lanes pattern. The mask layer may include, for example, a metal or metal alloy material, such as chromium or chromium oxide. The mask layer may have a high resistance to dry etching, such as plasma etching. The etching process may then be performed to remove the bonding material from the bonding layer 1420 in the one or more dicing lanes 1422. In one aspect, a lithographic patterning process may be implemented that includes a positive tone development or a negative tone development.

At operation 1470, a second waveguide layer 1430 is bonded onto first waveguide layer 1410 using bonding layer 1420 in a bonding process to form a bonded waveguide stack 1435. The bonding process may include ultraviolet curing and/or a thermal bonding process. In one implementation, second waveguide layer 1430 may have a lower refractive index than first waveguide layer 1410 in order to, for example, cause a refractive index modulation.

At operation 1480, a dicing process is performed to form one or more individual layered waveguides 1440 (also referred to as layered waveguide devices) from the bonded waveguide stack 1435. The dicing process may include laser ablation or other like technique for cutting in the one or more dicing lanes 1422 through the bonded waveguide stack 1435. Although not shown, in another implementation, the process depicted in FIG. 14 may also include forming (e.g., by etching) one or more input gratings and/or output gratings in, or on an outer surface of, the first waveguide layer 1410 and/or the second waveguide layer 1430. The input gratings and/or output gratings may include, e.g., slanted or vertical surface-relief gratings.

In FIG. 14, the bonding material layer 1420 is disposed over the entire first waveguide layer 1410 except in the one or more dicing lanes 1422. In other implementations, the bonding material layer 1420 may be disposed in an area over the one or more waveguide dies 1412 and not in at least a portion of the area outside the one or more dicing lanes 1422. In another implementation, waveguide dies 1412 may lie within the one or more dicing lanes 1422.

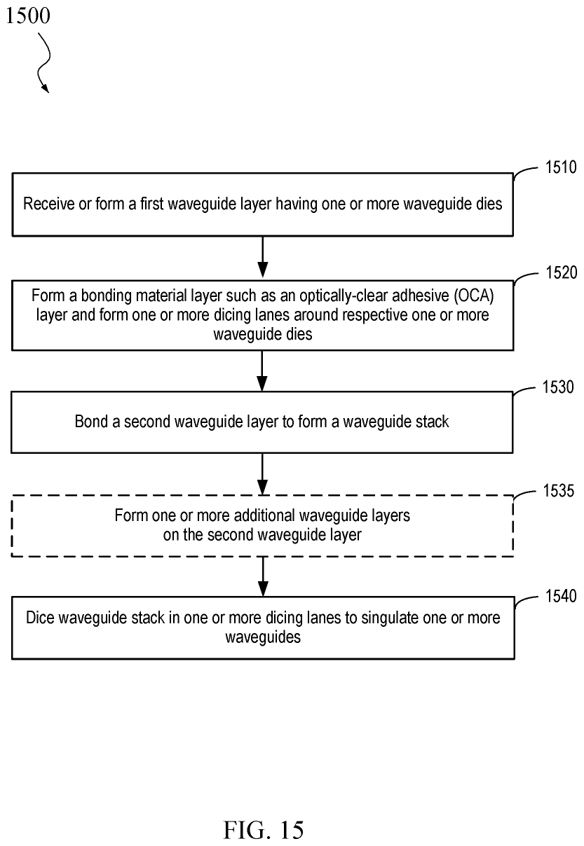

FIG. 15 includes a flowchart 1500 depicting operations of an example of a method of fabricating a layered waveguide, according to embodiments. Some of the operations may be similar to those depicted in FIG. 14. The operations described in diagram 1500 are for illustration purposes only and are not intended to be limiting. In various implementations, modifications may be made to diagram 1500 to add additional operations, omit some operations, or change the order of the operations. For example, although not shown, the process may also include forming one or more input gratings and/or output gratings in, or on an outer surface of, the first waveguide layer and/or the second waveguide layer. The input gratings and/or output gratings may include, e.g., slanted or vertical surface-relief gratings. One or more operations described in diagram 1500 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (ME)) system, and the like.

At operation 1510, a first waveguide layer (e.g., a wafer of glass, silicon, silicon nitride, silicon carbide, LiNbO₃, TiO₂, GaN, AlN, SiC, CVD diamond, ZnS, etc.) having one or more waveguide dies is received or formed (e.g., using a deposition technique described herein). In one implementation, the first waveguide layer may have one or more input gratings and/or output gratings formed in, or formed on a surface of, the first waveguide layer.

At operation 1520, an optically-clear adhesive (OCA) material or other bonding material is deposited on the first waveguide layer and one or more dicing lanes are formed in the bonding material layer. In certain implementations, the one or more dicing lanes may be formed as part of an additive process of depositing the bonding material in areas of the first waveguide layer outside of the dicing lanes using depositing techniques described herein. For example, an inkjet process or a drop cast process may be used to selectively deposit bonding material (e.g., an OCA material) on areas of the first waveguide layer outside of the one or more dicing lanes. In this example, the one or more dicing lanes may be kept free or substantially free of the bonding material. In other implementations, a subtractive process may be used to remove material at the one ore more dicing lanes exposing the first waveguide layer. For example, the bonding layer may be deposited such as, e.g., by spin coating, and an etching process such as lithographic process may be employed to remove material from the one or more dicing lanes. Before the etching process, a mask layer may be patterned on the first waveguide layer with the dicing lanes pattern. The mask layer may include, for example, a metal or metal alloy material, such as chromium or chromium oxide. The mask layer may have a high resistance to dry etching, such as plasma etching. The etching process may then be performed to remove the bonding material from the bonding layer in the one or more dicing lanes. In one aspect, a lithographic patterning process may be implemented that includes a positive tone development or a negative tone development.

At operation 1530, a second waveguide layer is bonded, in a bonding process, onto the first waveguide layer with the bonding material deposited in operation 1520 to form a bonded waveguide stack. The bonding process may include ultraviolet curing and/or a thermal bonding process. In one implementation, the second waveguide layer may have a lower refractive index than first waveguide layer. The respective refractive indices of the first and second waveguide layers may be selected for a desired refractive index modulation. The bonded waveguide stack may have one or more dicing lanes that are free, or substantially free, of bonding material. In one implementation, the bonding material is disposed over the entire first waveguide layer except in the one or more dicing lanes. In another implementation, the bonding material may be disposed only within the inner perimeter(s) of the one or the dicing lanes. In some cases, the one or more dicing lanes circumscribe the one or more waveguide dies and do not overlap or include a portion of the one or more waveguide dies. In other cases, the one or more waveguide dies lie within the respective one or more dicing lanes.

At optional (depicted by dashed line) operation 1535, one or more additional waveguide layers are bonded to the second waveguide layer and/or the first waveguide layer to supplement the bonded waveguide stack. For example, each additional waveguide layer may be formed on the waveguide stack by depositing an additional bonding layer and, in a bonding step, bonding the respective additional waveguide layer. In certain aspects, the first waveguide layer may have a higher refractive index than the second waveguide layer and/or other additional waveguide layers in the stack to cause refractive index modulation at each interface. For example, the refractive indices of the waveguide layers may decrease from the first waveguide layer through subsequent bonded waveguide layers. In certain instances, the materials and thicknesses of the waveguide layers in the stack may selectively couple wavelengths of light through layers in the waveguides.

At operation 1540, a dicing process is performed to cut through the bonding waveguide stack at the one or more dicing lanes to form one or more individual layered waveguides. The dicing process may include laser ablation or other like technique for cutting through the waveguide stack.

Methods of Fabricating Layered Waveguides with Selective Deposition/Removal and Sacrificial Material in Dicing Lane(s)

In certain implementations, methods of fabricating layered waveguides form a sacrificial material in one or more dicing lanes in a bonding layer between waveguide layers. The sacrificial material may be a material that typically does not bond to the bonding layer. In one aspect, the sacrificial material is an inert polymer material. In another aspect, the sacrificial material has orthogonal reactivity with the material of the bonding layer.

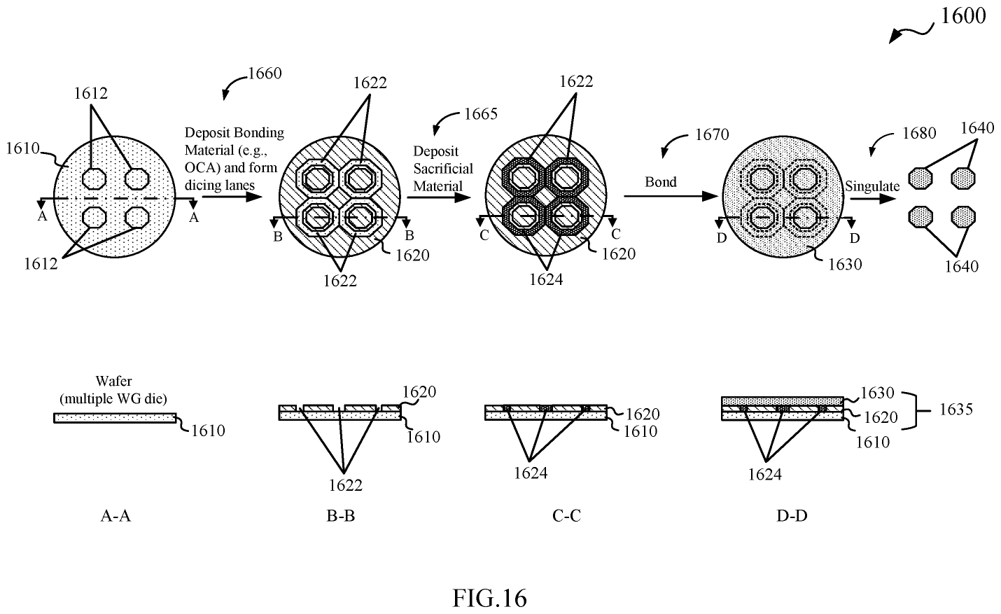

FIG. 16 includes a diagram 1600 illustrating an example of a process flow depicting operations of a method of fabricating a layered waveguide, according to embodiments. The operations described in diagram 1600 are for illustration purposes only and are not intended to be limiting. In various implementations, modifications may be made to diagram 1600 to add additional operations, omit some operations, or change the order of the operations. One or more operations described in diagram 1600 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (RIE)) system, and the like.

FIG. 16 depicts a first waveguide layer 1610 (e.g., a wafer of glass, silicon, silicon nitride, silicon carbide, LiNbO₃, TiO₂, GaN, AlN, SiC, CVD diamond, ZnS, etc.) having one or more waveguide dies 1612. At operation 1660, an optically-clear adhesive material layer or other bonding material layer 1620 of, for example, a transparent material, is deposited on the first waveguide layer 1610 with one or more dicing lanes 1622 formed in the bonding layer 1620. In certain implementations, the one or more dicing lanes 1622 may be formed as part of an additive process of depositing the bonding material in areas of the first waveguide layer 1610 outside of the one or more dicing lanes 1622 using depositing techniques described herein. For example, an inkjet process or a drop cast process may be used to selectively deposit bonding material (e.g., an OCA material) on areas of the first waveguide layer 1610 outside of the one ore more dicing lanes 1622. In other implementations, a subtractive process may be used to remove material at the one or more dicing lanes 1622 exposing the first waveguide layer 1610. For example, the bonding layer 1620 may be deposited such as, e.g., by spin coating, and an etching process such as lithographic process may be employed to remove material from the one or more dicing lanes 1622. Before the etching process, a mask layer may be patterned on the first waveguide layer 1610 with the dicing lanes pattern. The mask layer may include, for example, a metal or metal alloy material, such as chromium or chromium oxide. The mask layer may have a high resistance to dry etching, such as plasma etching. The etching process may then be performed to remove the bonding material from the bonding layer 1620 in the one or more dicing lanes 1622. In one aspect, a lithographic patterning process may be implemented that includes a positive tone development or a negative tone development.

At operation 1665, a sacrificial material 1624 is deposited into the one or more dicing lanes 1622. For example, an inkjet deposition process or a drop cast process may be used to selectively deposit sacrificial material 1624 into the one or more dicing lanes 1622 of the bonding layer 1620. The sacrificial material may be a material that typically does not bond to the bonding layer. In one aspect, the sacrificial material is an inert polymer material. In another aspect, the sacrificial material has orthogonal reactivity with the material of the bonding layer.

At operation 1670, a second waveguide layer 1630 is bonded onto first waveguide layer 1610 using bonding layer 1620 in a bonding process to form a bonded waveguide stack 1635. The bonding process may include ultraviolet curing and/or a thermal bonding process. In one implementation, second waveguide layer 1630 may have a lower refractive index than first waveguide layer 1610 in order to, for example, cause a refractive index modulation.

At operation 1680, a dicing process is performed to form one or more individual layered waveguides 1640 (also referred to as layered waveguide devices) from the bonded waveguide stack 1635. The dicing process may include laser ablation or other like technique for cutting in the one or more dicing lanes 1622 through the bonded waveguide stack 1635. Although not shown, in another implementation, the process depicted in FIG. 16 may also include forming (e.g., by etching) one or more input gratings and/or output gratings in, or on an outer surface of, the first waveguide layer 1610 and/or the second waveguide layer 1630. The input gratings and/or output gratings may include, e.g., slanted or vertical surface-relief gratings.

In FIG. 16, the bonding material layer 1620 is disposed over the entire first waveguide layer 1610 except in the one or more dicing lanes 1622. In other implementations, the bonding material layer 1620 may be disposed in an area over the one or more waveguide dies 1612 and not in at least a portion of the area outside the one or more dicing lanes 1622. In another implementation, waveguide dies 1612 may lie within the one or more dicing lanes 1622.

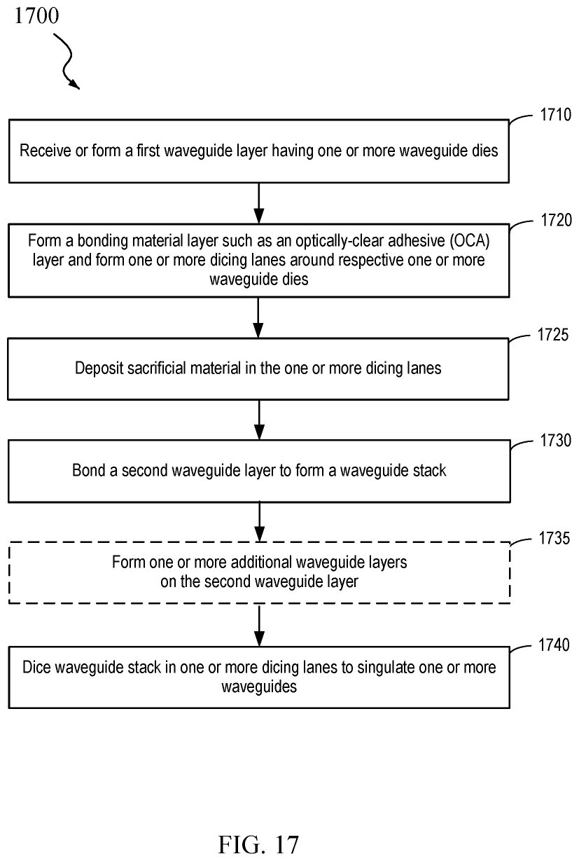

FIG. 17 includes a flowchart 1700 depicting operations of an example of a method of fabricating a layered waveguide, according to embodiments. Some of the operations may be similar to those depicted in FIG. 14 and FIG. 16. The operations described in diagram 1700 are for illustration purposes only and are not intended to be limiting. In various implementations, modifications may be made to diagram 1700 to add additional operations, omit some operations, or change the order of the operations. For example, although not shown, the process may also include forming one or more input gratings and/or output gratings in, or on an outer surface of, the first waveguide layer and/or the second waveguide layer. The input gratings and/or output gratings may include, e.g., slanted or vertical surface-relief gratings. One or more operations described in diagram 1700 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (ME)) system, and the like.

At operation 1710, a first waveguide layer (e.g., a wafer of glass, silicon, silicon nitride, silicon carbide, LiNbO₃, TiO₂, GaN, AlN, SiC, CVD diamond, ZnS, etc.) having one or more waveguide dies is received or formed (e.g., using a deposition technique described herein). In one implementation, the first waveguide layer may have one or more input gratings and/or output gratings formed in, or formed on a surface of, the first waveguide layer.

At operation 1720, an optically-clear adhesive (OCA) material or other bonding material is deposited on the first waveguide layer and one or more dicing lanes are formed in the bonding material layer. In certain implementations, the one or more dicing lanes may be formed as part of an additive process of depositing the bonding material in areas of the first waveguide layer outside of the dicing lanes using depositing techniques described herein. For example, an inkjet process or a drop cast process may be used to selectively deposit bonding material (e.g., an OCA material) on areas of the first waveguide layer outside of the one or more dicing lanes. In other implementations, a subtractive process may be used to remove material at the one or more dicing lanes exposing the first waveguide layer. For example, the bonding layer may be deposited such as, e.g., by spin coating, and an etching process such as lithographic process may be employed to remove material from the one or more dicing lanes. Before the etching process, a mask layer may be patterned on the first waveguide layer with the dicing lanes pattern. The mask layer may include, for example, a metal or metal alloy material, such as chromium or chromium oxide. The mask layer may have a high resistance to dry etching, such as plasma etching. The etching process may then be performed to remove the bonding material from the bonding layer in the one or more dicing lanes. In one aspect, a lithographic patterning process may be implemented that includes a positive tone development or a negative tone development.

At operation 1725, a sacrificial material is deposited into the one or more dicing lanes. For example, an inkjet process or a drop cast process may be used to selectively deposit sacrificial material into the one or more dicing lanes.

At operation 1730, a second waveguide layer is bonded, in a bonding process, onto the first waveguide layer with a bonding layer such as an OCA material. The bonding process may include ultraviolet curing and/or thermal bonding process.

At operation 1730, a second waveguide layer is bonded, in a bonding process, onto the first waveguide layer with the bonding material having one or more dicing lanes with sacrificial material to form a bonded waveguide stack. The bonding process may include ultraviolet curing and/or a thermal bonding process. In one implementation, the second waveguide layer may have a lower refractive index than first waveguide layer. The respective refractive indices of the first and second waveguide layers may be selected for a desired refractive index modulation. The bonded waveguide stack may have one or more dicing lanes that are free, or substantially free, of bonding material. In one implementation, the bonding material is disposed over the entire first waveguide layer except in the one or more dicing lanes. In another implementation, the bonding material may be disposed only within the inner perimeter(s) of the one or the dicing lanes. In some cases, the one or more dicing lanes circumscribe the one or more waveguide dies and do not overlap or include a portion of the one or more waveguide dies. In other cases, the one or more waveguide dies lie within the respective one or more dicing lanes.

At optional (depicted by dashed line) operation 1735, one or more additional waveguide layers are bonded to the second waveguide layer and/or the first waveguide layer to supplement the bonded waveguide stack. For example, each additional waveguide layer may be formed on the waveguide stack by depositing an additional bonding layer and, in a bonding step, bonding the respective additional waveguide layer. In certain aspects, the first waveguide layer may have a higher refractive index than the second waveguide layer and/or other additional waveguide layers in the stack to cause refractive index modulation at each interface. For example, the refractive indices of the waveguide layers may decrease from the first waveguide layer through subsequent bonded waveguide layers. In certain instances, the materials and thicknesses of the waveguide layers in the stack may selectively couple wavelengths of light through layers in the waveguides.

At operation 1740, a dicing process is performed to cut through the bonding waveguide stack in the one or more dicing lanes and through the sacrificial material to form one or more individual layered waveguides. The dicing process may include laser ablation or other like technique for cutting through the waveguide stack.

In an alternative implementation, the sacrificial material may be deposited prior to depositing the bonding material at operation 1720. In this implementation, the sacrificial material may act as a damn during deposition of the bonding layer material, for example, in a drop cast process or like process. During deposition of the bonding material, the sacrificial material acts as a damn maintaining the bonding material within the region around the waveguide dies and in a region inside the one or more dicing lanes.

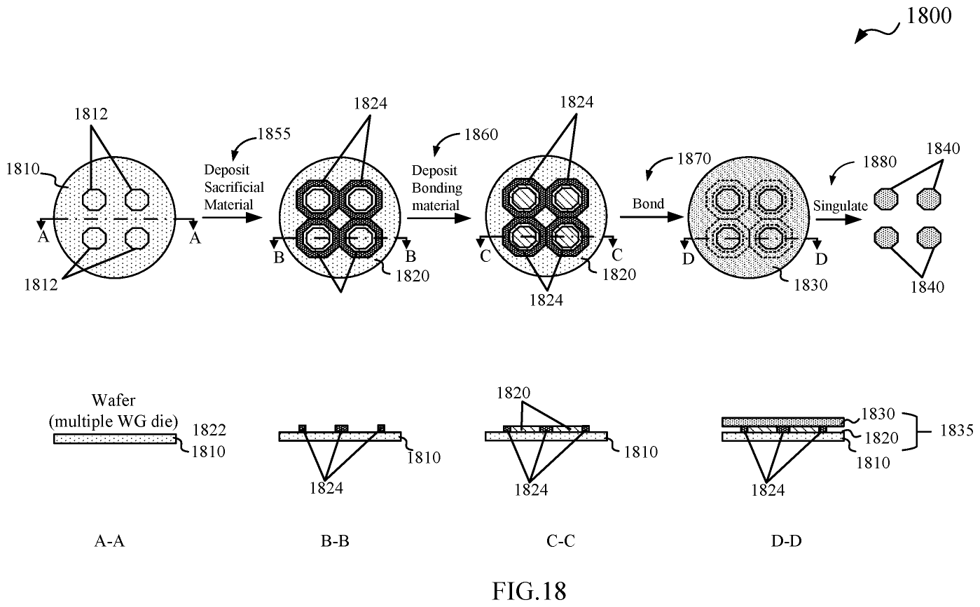

FIG. 18 includes a diagram 1800 illustrating an example of a process flow depicting operations of a method of fabricating a layered waveguide, according to embodiments. The operations described in diagram 1800 are for illustration purposes only and are not intended to be limiting. In various implementations, modifications may be made to diagram 1800 to add additional operations, omit some operations, or change the order of the operations. One or more operations described in diagram 1800 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (RIE)) system, and the like.

FIG. 18 depicts a first waveguide layer 1810 (e.g., a wafer of glass, silicon, silicon nitride, silicon carbide, LiNbO₃, TiO₂, GaN, AlN, SiC, CVD diamond, ZnS, etc.) having one or more waveguide dies 1812.

At operation 1855, a sacrificial material 1824 is formed on the first waveguide layer 1810 in one or more dicing lanes 1822. In one implementation, an inkjet process or a drop cast process, or other additive process may be used to selectively deposit sacrificial material 1824 in the one or more dicing lanes 1822. In another implementation, a subtractive process may be used to form the sacrificial material 1824 in the one or more dicing lanes 1822. For example, sacrificial material 1824 may be deposited on the first waveguide layer 1810 and an etching process may be employed to remove sacrificial material outside the one or more dicing lanes 1822 according to, e.g., a dicing lanes pattern. Before the etching process, a mask layer may be patterned on the first waveguide layer 1810 with the dicing lanes pattern. The mask layer may include, for example, a metal or metal alloy material, such as chromium or chromium oxide. The mask layer may have a high resistance to dry etching, such as plasma etching. The etching process may then be performed to remove sacrificial material from the first waveguide layer 1810 outside the one or more dicing lanes 1822 and leaving sacrificial material 1825 in the one or more dicing lanes 1822. In one aspect, a lithographic patterning process may be implemented that includes a positive tone development or a negative tone development. The sacrificial material may be a material that typically does not bond to the bonding layer. In one aspect, the sacrificial material is an inert polymer material. In another aspect, the sacrificial material has orthogonal reactivity with the material of the bonding layer.

At operation 1860, an optically-clear adhesive material layer or other bonding material layer 1820 is deposited on first waveguide layer 1810 in one or more regions bound by the inner perimeters of sacrificial material 1824 within the one or more dicing lanes 1824. For example, a drop cast process or like process may be used to deposit the bonding material (e.g., an OCA) within the one or more regions and the bonding material may spread until reaching the sacrificial material 1824. The sacrificial material 1824 may act as a dam to maintain the bonding material 1820 within the one or more regions within inner perimeters of the sacrificial material 1824 and within dicing lanes 1822. In the illustrated example, the one or more regions circumscribe and are outside areas above the waveguide dies 1812. In another example, the one or more regions are above the waveguide dies 1812. The bonding material 1820 may be formed as part of an additive process using depositing techniques described herein. For example, an inkjet process or a drop cast process may be used to selectively deposit bonding material within the one or more dicing lanes 1824.

At operation 1870, a second waveguide layer 1830 is bonded onto first waveguide layer 1810 using bonding layer 1820 in a bonding process to form a bonded waveguide stack 1835. The bonding process may include ultraviolet curing and/or a thermal bonding process. In one implementation, second waveguide layer 1830 may have a lower refractive index than first waveguide layer 1810 in order to, for example, cause a refractive index modulation.

At operation 1880, a dicing process is performed to form one or more individual layered waveguides 1840 (also referred to as layered waveguide devices) from the bonded waveguide stack 1835. The dicing process may include laser ablation or other like technique for cutting in the one or more dicing lanes 1822 through the bonded waveguide stack 1835. Although not shown, in another implementation, the process depicted in FIG. 18 may also include forming (e.g., by etching) one or more input gratings and/or output gratings in, or on an outer surface of, the first waveguide layer 1810 and/or the second waveguide layer 1830. The input gratings and/or output gratings may include, e.g., slanted or vertical surface-relief gratings.

In FIG. 18, the bonding material 1820 is disposed within the inner perimeters of the one or more dicing lanes 1822. In other implementations, the bonding material 1820 may be disposed in one or more areas over the one or more waveguide dies 1812. In one aspect, the bonding material 1820 may not be disposed in ay region to the outside of the one or more dicing lanes 1822.

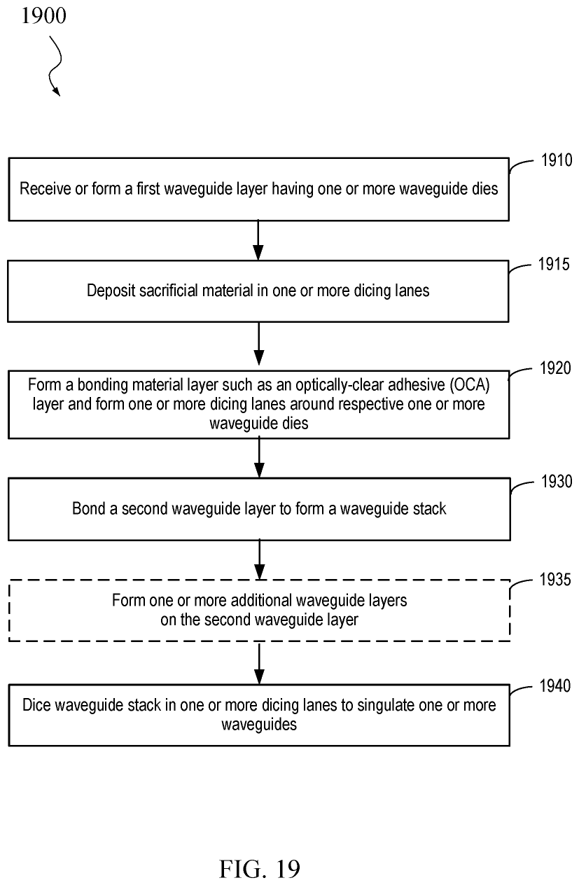

FIG. 19 includes a flowchart 1900 depicting an example of operations of a method of fabricating a multi-layer waveguide, according to certain embodiments. Some of the operations may be similar to those depicted in FIG. 18. The operations described in diagram 1900 are for illustration purposes only and are not intended to be limiting. In various implementations, modifications may be made to diagram 1900 to add additional operations, omit some operations, or change the order of the operations. For example, although not shown, the process may also include forming one or more input gratings and/or output gratings in, or on an outer surface of, the first waveguide layer and/or the second waveguide layer. The input gratings and/or output gratings may include, e.g., slanted or vertical surface-relief gratings. One or more operations described in diagram 1900 may be performed using, for example, one or more semiconductor fabrication systems, such as an inkjet system, a spin coating system, a chemical vapor deposition (CVD) system, a physical vapor deposition (PVD) system, an ion or plasma etching (e.g., ion beam etching (IBE), plasma etching (PE), or reactive ion etching (ME)) system, and the like.

At operation 1910, a first waveguide layer (e.g., a wafer of glass, silicon, silicon nitride, silicon carbide, LiNbO₃, TiO₂, GaN, AlN, SiC, CVD diamond, ZnS, etc.) having one or more waveguide dies is received or formed (e.g., using a deposition technique described herein). In one implementation, the first waveguide layer may have one or more input gratings and/or output gratings formed in, or formed on a surface of, the first waveguide layer.

At operation 1915, a sacrificial material is formed on the first wave guide layer according to (e.g., in accordance with a dicing lane pattern) one or more dicing lanes. In one implementation, an inkjet process, a drop cast process, or other selective additive process may be used to selectively deposit the sacrificial material in the one or more dicing lanes such as, e.g. dicing lanes 1822 shown in FIG. 18. In another implementation, a subtractive process may be used to form the sacrificial material in the one or more dicing lanes. For example, the sacrificial material may be deposited on the first waveguide layer and an etching process may be employed to remove sacrificial material outside the one or more dicing lanes according to a dicing lanes pattern that is patterned on the first waveguide layer. Before the etching process, a mask layer may be patterned on the first waveguide layer with the dicing lanes pattern. The mask layer may include, for example, a metal or metal alloy material, such as chromium or chromium oxide. The mask layer may have a high resistance to dry etching, such as plasma etching. The etching process may then be performed to remove sacrificial material from the first waveguide layer outside of the one or more dicing lanes. In one aspect, a lithographic patterning process may be implemented that includes a positive tone development or a negative tone development. The sacrificial material may be a material that typically does not bond to the bonding layer. In one aspect, the sacrificial material is an inert polymer material. In another aspect, the sacrificial material has orthogonal reactivity with the material of the bonding layer.

At operation 1920, an optically-clear adhesive material layer or other bonding material layer is deposited on the first waveguide layer in one or more regions bound by the inner perimeters of sacrificial material within the one or more dicing lanes. For example, a drop cast process or like process may be used to deposit the bonding material (e.g., an OCA) within the one or more regions and the bonding material may spread until reaching the sacrificial material. The sacrificial material may act as a dam to maintain the bonding material within the one or more regions within perimeters of the sacrificial material and within dicing lanes. In the illustrated example, the one or more regions circumscribe and are outside areas above the waveguide dies. In another example, the one or more regions are above the waveguide dies. The bonding material may be formed as part of an additive process using depositing techniques described herein. For example, an inkjet process or a drop cast process may be used to selectively deposit bonding material within the one or more dicing lanes.

At operation 1930, a second waveguide layer is bonded, in a bonding process, onto the first waveguide layer with the bonding material having one or more dicing lanes with sacrificial material to form a bonded waveguide stack. The bonding process may include ultraviolet curing and/or a thermal bonding process. In one implementation, the second waveguide layer may have a lower refractive index than first waveguide layer. The respective refractive indices of the first and second waveguide layers may be selected for a desired refractive index modulation. The bonded waveguide stack may have one or more dicing lanes that are free, or substantially free, of bonding material. In this example, the bonding material is disposed only within the inner perimeter(s) of the one or the dicing lanes. In some cases, the one or more dicing lanes circumscribe the one or more waveguide dies and do not overlap or include a portion of the one or more waveguide dies. In other cases, the one or more waveguide dies lie within the respective one or more dicing lanes.

At optional (depicted by dashed line) operation 1935, one or more additional waveguide layers are bonded to the second waveguide layer and/or the first waveguide layer to supplement the bonded waveguide stack. For example, each additional waveguide layer may be formed on the waveguide stack by depositing an additional bonding layer and, in a bonding step, bonding the respective additional waveguide layer. In certain aspects, the first waveguide layer may have a higher refractive index than the second waveguide layer and/or other additional waveguide layers in the stack to cause refractive index modulation at each interface. For example, the refractive indices of the waveguide layers may decrease from the first waveguide layer through subsequent bonded waveguide layers. In certain instances, the materials and thicknesses of the waveguide layers in the stack may selectively couple wavelengths of light through layers in the waveguides.

At operation 1940, a dicing process is performed to cut through the bonding waveguide stack in the one or more dicing lanes and through the sacrificial material to form one or more individual layered waveguides. The dicing process may include laser ablation or other like technique for cutting through the waveguide stack.

Although the illustrated examples of layered waveguides in FIGS. 14, 16, and 18 have dicing lanes located within, at a distance from, inner perimeters of the one or more dicing lanes (e.g., dicing lanes 1422 and waveguide dies 1412 shown in FIG. 14, dicing lanes 1622 and waveguide dies 1612 shown in FIG. 16, and dicing lanes 1822 and waveguide dies 1812 shown in FIG. 18), the disclosure is not som limiting. In other implementations the one or more waveguide dies may be located within the one or more dicing lanes.

In certain aspects, the method of fabricating a multi-layer waveguide described with respect to FIGS. 12, 13, 14, 15, 16, 17, 18, and 19 may also include operations to form one or more grating couplers to form a multi-layer waveguide display.

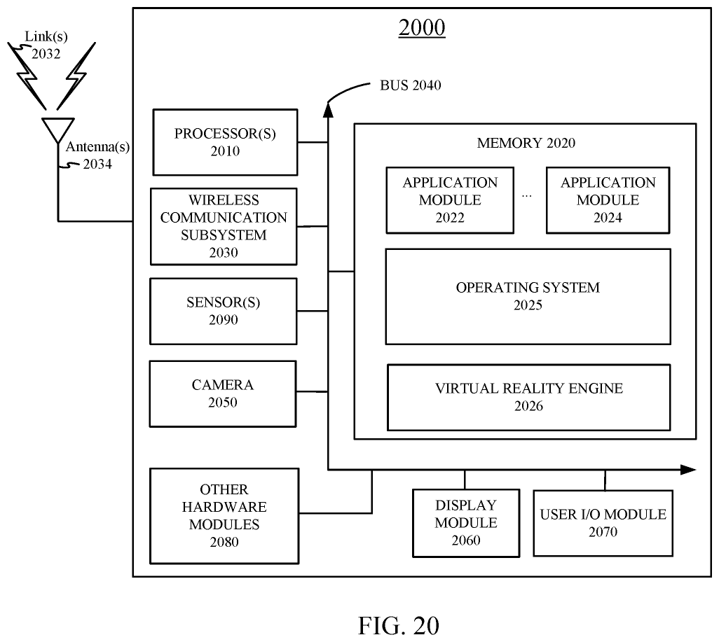

FIG. 20 is a simplified block diagram of an example electronic system 2000 of an example near-eye display (e.g., HMD device) for implementing some of the examples disclosed herein. Electronic system 2000 may be used as the electronic system of an HMD device or other near-eye displays described above. In this example, electronic system 2000 may include one or more processor(s) 2010 and a memory 2020. Processor(s) 2010 may be configured to execute instructions for performing operations at a number of components, and can be, for example, a general-purpose processor or microprocessor suitable for implementation within a portable electronic device. Processor(s) 2010 may be communicatively coupled with a plurality of components within electronic system 2000. To realize this communicative coupling, processor(s) 2010 may communicate with the other illustrated components across a bus 2040. Bus 2040 may be any subsystem adapted to transfer data within electronic system 2000. Bus 2040 may include a plurality of computer buses and additional circuitry to transfer data.

Memory 2020 may be coupled to processor(s) 2010. In some embodiments, memory 2020 may offer both short-term and long-term storage and may be divided into several units. Memory 2020 may be volatile, such as static random access memory (SRAM) and/or DRAM and/or non-volatile, such as read-only memory (ROM), flash memory, and the like. Furthermore, memory 2020 may include removable storage devices, such as secure digital (SD) cards. Memory 2020 may provide storage of computer-readable instructions, data structures, program modules, and other data for electronic system 2000. In some embodiments, memory 2020 may be distributed into different hardware modules. A set of instructions and/or code might be stored on memory 2020. The instructions might take the form of executable code that may be executable by electronic system 2000, and/or might take the form of source and/or installable code, which, upon compilation and/or installation on electronic system 2000 (e.g., using any of a variety of generally available compilers, installation programs, compression/decompression utilities, etc.), may take the form of executable code.

In some embodiments, memory 2020 may store a plurality of application modules 2022 through 2024, which may include any number of applications. Examples of applications may include gaming applications, conferencing applications, video playback applications, or other suitable applications. The applications may include a depth sensing function or eye tracking function. Application modules 2022-2024 may include particular instructions to be executed by processor(s) 2010. In some embodiments, certain applications or parts of application modules 2022-2024 may be executable by other hardware modules 2080. In certain embodiments, memory 2020 may additionally include secure memory, which may include additional security controls to prevent copying or other unauthorized access to secure information.

In some embodiments, memory 2020 may include an operating system 2025 loaded therein. Operating system 2025 may be operable to initiate the execution of the instructions provided by application modules 2022-2024 and/or manage other hardware modules 2080 as well as interfaces with a wireless communication subsystem 2030 which may include one or more wireless transceivers. Operating system 2025 may be adapted to perform other operations across the components of electronic system 2000 including threading, resource management, data storage control and other similar functionality.

Wireless communication subsystem 2030 may include, for example, an infrared communication device, a wireless communication device and/or chipset (such as a Bluetooth® device, an IEEE 802.11 device, a Wi-Fi device, a WiMax device, cellular communication facilities, etc.), and/or similar communication interfaces. Electronic system 2000 may include one or more antennas 2034 for wireless communication as part of wireless communication subsystem 2030 or as a separate component coupled to any portion of the system. Depending on desired functionality, wireless communication subsystem 2030 may include separate transceivers to communicate with base transceiver stations and other wireless devices and access points, which may include communicating with different data networks and/or network types, such as wireless wide-area networks (WWANs), wireless local area networks (WLANs), or wireless personal area networks (WPANs). A WWAN may be, for example, a WiMax (IEEE 802.16) network. A WLAN may be, for example, an IEEE 802.11x network. A WPAN may be, for example, a Bluetooth network, an IEEE 802.17x, or some other types of network. The techniques described herein may also be used for any combination of WWAN, WLAN, and/or WPAN. Wireless communications subsystem 2030 may permit data to be exchanged with a network, other computer systems, and/or any other devices described herein. Wireless communication subsystem 2030 may include a means for transmitting or receiving data, such as identifiers of HMD devices, position data, a geographic map, a heat map, photos, or videos, using antenna(s) 2034 and wireless link(s) 2032. Wireless communication subsystem 2030, processor(s) 2010, and memory 2020 may together comprise at least a part of one or more of a means for performing some functions disclosed herein.

Embodiments of electronic system 2000 may also include one or more sensors 2090. Sensor(s) 2090 may include, for example, an image sensor, an accelerometer, a pressure sensor, a temperature sensor, a proximity sensor, a magnetometer, a gyroscope, an inertial sensor (e.g., a module that combines an accelerometer and a gyroscope), an ambient light sensor, or any other similar module operable to provide sensory output and/or receive sensory input, such as a depth sensor or a position sensor. For example, in some implementations, sensor(s) 2090 may include one or more inertial measurement units (IMUs) and/or one or more position sensors. An IMU may generate calibration data indicating an estimated position of the HMD device relative to an initial position of the HMD device, based on measurement signals received from one or more of the position sensors. A position sensor may generate one or more measurement signals in response to motion of the HMD device. Examples of the position sensors may include, but are not limited to, one or more accelerometers, one or more gyroscopes, one or more magnetometers, another suitable type of sensor that detects motion, a type of sensor used for error correction of the IMU, or some combination thereof. The position sensors may be located external to the IMU, internal to the IMU, or some combination thereof. At least some sensors may use a structured light pattern for sensing.

Electronic system 2000 may include a display module 2060. Display module 2060 may be a near-eye display, and may graphically present information, such as images, videos, and various instructions, from electronic system 2000 to a user. Such information may be derived from one or more application modules 2022-2024, virtual reality engine 2026, one or more other hardware modules 2080, a combination thereof, or any other suitable means for resolving graphical content for the user (e.g., by operating system 2025). Display module 2060 may use liquid crystal display (LCD) technology, LED technology (including, for example, OLED, ILED, μLED, AMOLED, TOLED, etc.), light emitting polymer display (LPD) technology, or some other display technology.

Electronic system 2000 may include a user input/output module 2070. User input/output module 2070 may allow a user to send action requests to electronic system 2000. An action request may be a request to perform a particular action. For example, an action request may be to start or end an application or to perform a particular action within the application. User input/output module 2070 may include one or more input devices. Example input devices may include a touchscreen, a touch pad, microphone(s), button(s), dial(s), switch(es), a keyboard, a mouse, a game controller, or any other suitable device for receiving action requests and communicating the received action requests to electronic system 2000. In some embodiments, user input/output module 2070 may provide haptic feedback to the user in accordance with instructions received from electronic system 2000. For example, the haptic feedback may be provided when an action request is received or has been performed.

Electronic system 2000 may include a camera 2050 that may be used to take photos or videos of a user, for example, for tracking the user's eye position. Camera 2050 may also be used to take photos or videos of the environment, for example, for VR, AR, or MR applications. Camera 2050 may include, for example, a complementary metal-oxide-semiconductor (CMOS) image sensor with a few millions or tens of millions of pixels. In some implementations, camera 2050 may include two or more cameras that may be used to capture 3D images.

In some embodiments, electronic system 2000 may include a plurality of other hardware modules 2080. Each of other hardware modules 2080 may be a physical module within electronic system 2000. While each of other hardware modules 2080 may be permanently configured as a structure, some of other hardware modules 2080 may be temporarily configured to perform specific functions or temporarily activated. Examples of other hardware modules 2080 may include, for example, an audio output and/or input module (e.g., a microphone or speaker), a near field communication (NFC) module, a rechargeable battery, a battery management system, a wired/wireless battery charging system, etc. In some embodiments, one or more functions of other hardware modules 2080 may be implemented in software.

In some embodiments, memory 2020 of electronic system 2000 may also store a virtual reality engine 2026. Virtual reality engine 2026 may execute applications within electronic system 2000 and receive position information, acceleration information, velocity information, predicted future positions, or some combination thereof of the HMD device from the various sensors. In some embodiments, the information received by virtual reality engine 2026 may be used for producing a signal (e.g., display instructions) to display module 2060. For example, if the received information indicates that the user has looked to the left, virtual reality engine 2026 may generate content for the HMD device that mirrors the user's movement in a virtual environment. Additionally, virtual reality engine 2026 may perform an action within an application in response to an action request received from user input/output module 2070 and provide feedback to the user. The provided feedback may be visual, audible, or haptic feedback. In some implementations, processor(s) 2010 may include one or more graphic processing units (GPUs) that may execute virtual reality engine 2026.

In various implementations, the above-described hardware and modules may be implemented on a single device or on multiple devices that can communicate with one another using wired or wireless connections. For example, in some implementations, some components or modules, such as GPUs, virtual reality engine 2026, and applications (e.g., tracking application), may be implemented on a console separate from the head-mounted display device. In some implementations, one console may be connected to or support more than one HMD.

In alternative configurations, different and/or additional components may be included in electronic system 2000. Similarly, functionality of one or more of the components can be distributed among the components in a manner different from the manner described above. For example, in some embodiments, electronic system 2000 may be modified to include other system environments, such as an AR system environment and/or an MR environment.

The methods, systems, and devices discussed above are examples. Various embodiments may omit, substitute, or add various procedures or components as appropriate. For instance, in alternative configurations, the methods described may be performed in an order different from that described, and/or various stages may be added, omitted, and/or combined. Also, features described with respect to certain embodiments may be combined in various other embodiments. Different aspects and elements of the embodiments may be combined in a similar manner. Also, technology evolves and, thus, many of the elements are examples that do not limit the scope of the disclosure to those specific examples.

Specific details are given in the description to provide a thorough understanding of the embodiments. However, embodiments may be practiced without these specific details. For example, well-known circuits, processes, systems, structures, and techniques have been shown without unnecessary detail in order to avoid obscuring the embodiments. This description provides example embodiments only, and is not intended to limit the scope, applicability, or configuration of the invention. Rather, the preceding description of the embodiments will provide those skilled in the art with an enabling description for implementing various embodiments. Various changes may be made in the function and arrangement of elements without departing from the spirit and scope of the present disclosure.

Also, some embodiments were described as processes depicted as flow diagrams or block diagrams. Although each may describe the operations as a sequential process, many of the operations may be performed in parallel or concurrently. In addition, the order of the operations may be rearranged. A process may have additional steps not included in the figure. Furthermore, embodiments of the methods may be implemented by hardware, software, firmware, middleware, microcode, hardware description languages, or any combination thereof. When implemented in software, firmware, middleware, or microcode, the program code or code segments to perform the associated tasks may be stored in a computer-readable medium such as a storage medium. Processors may perform the associated tasks.

It will be apparent to those skilled in the art that substantial variations may be made in accordance with specific requirements. For example, customized or special-purpose hardware might also be used, and/or particular elements might be implemented in hardware, software (including portable software, such as applets, etc.), or both. Further, connection to other computing devices such as network input/output devices may be employed.

With reference to the appended figures, components that can include memory can include non-transitory machine-readable media. The term “machine-readable medium” and “computer-readable medium,” as used herein, refer to any storage medium that participates in providing data that causes a machine to operate in a specific fashion. In embodiments provided hereinabove, various machine-readable media might be involved in providing instructions/code to processing units and/or other device(s) for execution. Additionally or alternatively, the machine-readable media might be used to store and/or carry such instructions/code. In many implementations, a computer-readable medium is a physical and/or tangible storage medium. Such a medium may take many forms, including, but not limited to, non-volatile media, volatile media, and transmission media. Common forms of computer-readable media include, for example, magnetic and/or optical media such as compact disk (CD) or digital versatile disk (DVD), punch cards, paper tape, any other physical medium with patterns of holes, a RAM, a programmable read-only memory (PROM), an erasable programmable read-only memory (EPROM), a FLASH-EPROM, any other memory chip or cartridge, a carrier wave as described hereinafter, or any other medium from which a computer can read instructions and/or code. A computer program product may include code and/or machine-executable instructions that may represent a procedure, a function, a subprogram, a program, a routine, an application (App), a subroutine, a module, a software package, a class, or any combination of instructions, data structures, or program statements.

Those of skill in the art will appreciate that information and signals used to communicate the messages described herein may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Terms, “and” and “or” as used herein, may include a variety of meanings that are also expected to depend at least in part upon the context in which such terms are used. Typically, “or” if used to associate a list, such as A, B, or C, is intended to mean A, B, and C, here used in the inclusive sense, as well as A, B, or C, here used in the exclusive sense. In addition, the term “one or more” as used herein may be used to describe any feature, structure, or characteristic in the singular or may be used to describe some combination of features, structures, or characteristics. However, it should be noted that this is merely an illustrative example and claimed subject matter is not limited to this example. Furthermore, the term “at least one of” if used to associate a list, such as A, B, or C, can be interpreted to mean any combination of A, B, and/or C, such as A, AB, AC, BC, AA, ABC, AAB, AABBCCC, etc.

Further, while certain embodiments have been described using a particular combination of hardware and software, it should be recognized that other combinations of hardware and software are also possible. Certain embodiments may be implemented only in hardware, or only in software, or using combinations thereof. In one example, software may be implemented with a computer program product containing computer program code or instructions executable by one or more processors for performing any or all of the steps, operations, or processes described in this disclosure, where the computer program may be stored on a non-transitory computer readable medium. The various processes described herein can be implemented on the same processor or different processors in any combination.

Where devices, systems, components or modules are described as being configured to perform certain operations or functions, such configuration can be accomplished, for example, by designing electronic circuits to perform the operation, by programming programmable electronic circuits (such as microprocessors) to perform the operation such as by executing computer instructions or code, or processors or cores programmed to execute code or instructions stored on a non-transitory memory medium, or any combination thereof. Processes can communicate using a variety of techniques, including, but not limited to, conventional techniques for inter-process communications, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific embodiments have been described, these are not intended to be limiting. Various modifications and equivalents are within the scope of the following claims.

What is claimed is:

1. A method of fabricating one or more multi-layer waveguides, the method comprising:
receiving or forming a first waveguide layer;
forming, on the first waveguide layer, a bonding layer with one or more dicing lanes;
bonding a second waveguide layer to the first waveguide layer to form a bonded waveguide stack; and
cutting through the bonded waveguide stack along the one or more dicing lanes to form one or more multi-layer waveguides.

2. The method of claim 1, wherein the bonding layer is formed by depositing an optically-clear adhesive material.

3. The method of claim 2, wherein the one or more dicing lanes are free of the optically-clear adhesive material.

4. The method of claim 1, wherein forming the bonding layer comprises ink jet depositing a two-dimensional array of droplets of an optically-clear adhesive material on the first waveguide layer.

5. The method of claim 4, wherein forming the optically-clear adhesive material comprises a base resin comprising a material selected from a group comprised of acrylates, epoxides, vinyls, thiols, allyls, vinylethers, allylethers, epoxyacrylates, urethane acrylates, and polyester acrylates.

6. The method of claim 5, wherein the optically-clear adhesive material further comprises nanoparticles comprising a metal oxide.

7. The method of claim 1, further comprising depositing a sacrificial material in the one or more dicing lanes.

8. The method of claim 7, wherein cutting through the bonded waveguide stack comprises cutting through the sacrificial material.

9. The method of claim 1, wherein the one or more dicing lanes are circumscribed about one or more waveguide dies in the first waveguide layer.

10. The method of claim 1, wherein the one or more dicing lanes are formed by (i) patterning the bonding layer using a photolithographic process or (ii) forming the bonding layer by selectively depositing an optically-clear adhesive material outside the one or more dicing lanes.

11. The method of claim 1, wherein one or both of the second waveguide layer and the bonding layer have a refractive index that is the same or lower than a refractive index of the first waveguide layer.

12. The method of claim 1, further comprising forming one or more input and/or output gratings in the first waveguide layer.

13. The method of claim 1, further comprising forming one or more additional waveguide layers on the bonded waveguide stack, each additional waveguide layer formed by:
depositing optically-clear adhesive material; and
bonding the additional waveguide layer.

14. The method of claim 1, wherein cutting through the bonded waveguide stack comprising applying laser ablation along the one or more dicing lanes.

15. A method of fabricating one or more multi-layer waveguide displays, the method comprising:
receiving or forming a first waveguide layer with one or more gratings;
forming, on the first waveguide layer, an optically-clear adhesive material layer with one or more dicing lanes;
bonding a second waveguide layer to the first waveguide layer to form a bonded waveguide stack;
cutting through the bonded waveguide stack along the one or more dicing lanes to form one or more multi-layer waveguides; and
forming the one or more multi-layer waveguides displays using the one or more multi-layer waveguides.

16. The method of claim 15, further comprising depositing a sacrificial material in at least a portion of the one or more dicing lanes.

17. The method of claim 15, wherein the one or more dicing lanes is free of optically-clear adhesive material.

18. One or more multi-layer waveguides fabricated by:
receiving or forming a first waveguide layer;
forming, on the first waveguide layer, an optically-clear adhesive material layer, the optically-clear adhesive material layer having one or more dicing lanes free of optically-clear adhesive material;
bonding a second waveguide layer to the first waveguide layer to form a waveguide stack; and
cutting through the bonded waveguide stack along the one or more dicing lanes to form the one or more multi-layer waveguides.

19. The one or more multi-layer waveguides multi-layer waveguide display of claim 18, wherein the multi-layer waveguide is fabricated further by depositing a sacrificial material at the one or more dicing lanes.

20. The one or more multi-layer waveguides of claim 18, wherein forming the optically-clear adhesive material layer comprises ink jet depositing droplets of an optically-clear adhesive material on the first waveguide layer.

21. The one or more multi-layer waveguides of claim 18, wherein one or both of the second waveguide layer and the optically-clear adhesive material layer has a refractive index that is the same or lower than a refractive index of the first waveguide layer.

22. A multi-layer waveguide display, comprising:
a layered waveguide fabricated by cutting through a bonded waveguide stack along one or more dicing lanes in at least one of a plurality of waveguide layers of the bonded waveguide stack, wherein the one or more dicing lanes is free of a bonding material; and
one or more grating couplers configured to diffractively couple display light into or out of the layered waveguide and/or refractively transmit ambient light through the layered waveguide.

23. The multi-layer waveguide display of claim 22, wherein the one or more dicing lines comprise a sacrificial material.

24. The multi-layer waveguide display of claim 23, wherein the sacrificial material is deposited before depositing a bonding layer on a first waveguide layer of the plurality of waveguide layers of the bonded waveguide stack.

25. A method of fabricating one or more multi-layer waveguides, the method comprising:
receiving or forming a first waveguide layer;
depositing, on the first waveguide layer, a sacrificial material in one or more regions along one or more dicing lanes;
depositing a bonding material at least in part within inner perimeters of the one or more regions with the sacrificial material;
bonding a second waveguide layer to the first waveguide layer with the bonding material to form a bonded waveguide stack; and
cutting through the bonded waveguide stack along the one or more dicing lanes to form one or more multi-layer waveguides.

26. The method of claim 25, wherein the bonding material is an optically-clear adhesive material and the one or more dicing lanes are free of the optically-clear adhesive material.

27. The method of claim 25, wherein depositing the bonding material comprises ink jet depositing a two-dimensional array of droplets of an optically-clear adhesive material on the first waveguide layer.

28. The method of claim 25, wherein one or both of the second waveguide layer and the bonding material have a refractive index that is the same or lower than a refractive index of the first waveguide layer.

29. The method of claim 25, further comprising forming one or more gratings at an outer surface of at least one of the first and second waveguide layers.
